(19) United States
(12) Patent Application Publication
(10) Pub. No.: US 2016/0282743 A1
(43) Pub. Date: Sep. 29, 2016

(54) LIQUID DEVELOPER

(71) Applicant: Kao Corporation, Chuo-ku (JP)

(72) Inventors: Nobumichi KAMIYOSHI, Wakayama-shi (JP); Tatsuya YAMADA, Wakayama-shi (JP)

(73) Assignee: Kao Corporation, Chuo-ku (JP)

(21) Appl. No.: 15/041,419

(22) Filed: Feb. 11, 2016

(30) Foreign Application Priority Data
Mar. 26, 2015 (JP) 2015-065106

(51) Int. Cl. G03G 9/13; G03G 9/08

(52) U.S. Cl. CPC G03G 9/132; G03G 9/081; G03G 9/0804

(57) ABSTRACT

A liquid developer containing a dispersion of toner particles containing a polyester resin P having an acid value of 3 mgKOH/g or more and 80 mgKOH/g or less and a pigment in an insulating liquid in the presence of a dispersant, wherein the dispersant contains a copolymer C obtained by polymerizing monomers containing a monomer having a basic functional group and a monomer having a silicone chain, wherein the monomer having a silicone chain has a weight-average molecular weight of 1,000 or more and 10,000 or less, and the copolymer C has a weight-average molecular weight of 10,000 or more and 80,000 or less, and wherein a mass ratio of the monomer having a basic functional group to the monomer having a silicone chain is 3/97 or more and 50/50 or less, and a method for producing the same. The liquid developer of the present invention can be suitably used in development of latent images formed in, for example, an electrophotographic method, an electrostatic recording method, an electrostatic printing method, or the like.

### FIELD OF THE INVENTION

The present invention relates to a liquid developer usable in development of latent images formed in, for example, an electrophotographic method, an electrostatic recording method, an electrostatic printing method, or the like, and a method for producing the same.

### BACKGROUND OF THE INVENTION

Electrophotographic developers are a dry-state developer in which toner components containing materials containing a colorant and a resin binder are used in a dry state, and a liquid developer in which toner components are dispersed in an insulating carrier liquid.

Liquid developers allow the toner particles to form into smaller particles, so that they give excellent image quality, thereby making it suitable for commercial printing applications.

Patent Document 1 (Japanese Patent Laid-Open No. 2004-302436) discloses a liquid developer comprising colored particles comprising at least a resin and a colored substance, and a liquid which serves as a dispersion medium thereof, wherein the colored particles are adhered to a latent image on a latent image carrier to develop the latent image, characterized in that the liquid developer contains charged substances having charges of reverse polarity to the colored particles as a dispersion promoter for promoting the dispersion of the colored particles in the liquid in a proportion of from 0.05 to 20 parts by weight, based on 1 part by weight of the colored particles.

Patent Document 2 (Japanese Patent Laid-Open No. 2012-215788) discloses a method for producing a liquid developer characterized by the steps of kneading a resin having an acidic group and a charge control agent containing a nitrogen atom to provide a kneaded mixture, and pulverizing the kneaded mixture in an insulating liquid containing a dispersant having a silicone chain and a basic functional group.

Patent Document 3 (Japanese Patent Laid-Open No. 2005-036220) discloses a non-aqueous solvent-based pigment dispersant which comprises a silicone-based graft copolymer and is soluble to a non-aqueous solvent, wherein the silicone-based graft copolymer contains a monomer constituting a main chain moiety which is insoluble to the non-aqueous solvent and a monomer constituting a graft moiety which is soluble to the non-aqueous solvent, wherein the monomer constituting a graft moiety contains a silicone-based macro-monomer having a polymerizable functional group at a terminal.

Patent Document 4 (Japanese Patent Laid-Open No. 2014-071370) discloses a liquid developer containing an insulating liquid and toner particles containing matrix particles containing a polyester resin and/or a styrene-acrylic resin and a colorant, wherein the insulating liquid contains a silanol group-containing polysiloxane and/or a fluorine-modified silicone, and wherein in the toner particles an acrylic-modified silicone which is substantially soluble to the insulating liquid is adhered to the matrix particles.

### SUMMARY OF THE INVENTION

The present invention relates to:

[1] a liquid developer containing a dispersion of toner particles containing a polyester resin P having an acid value of 3 mgKOH/g or more and 80 mgKOH/g or less and a pigment in an insulating liquid in the presence of a dispersant, wherein the dispersant contains a copolymer C obtained by polymerizing monomers containing a monomer having a basic functional group and a monomer having a silicone chain, wherein the monomer having a silicone chain has a weight-average molecular weight of 1,000 or more and 10,000 or less, and the copolymer C has a weight-average molecular weight of 10,000 or more and 80,000 or less, and wherein a mass ratio of the monomer having a basic functional group to the monomer having a silicone chain is 3/97 or more and 50/50 or less; and
[2] a method for producing a liquid developer, including:

step 1: melt-kneading at least a polyester resin P having an acid value of 3 mgKOH/g or more and 80 mgKOH/g or less and a pigment, and pulverizing a kneaded mixture obtained to provide toner particles; and

step 2: dispersing the toner particles obtained in the step 1 in an insulating liquid in the presence of a dispersant,

wherein the dispersant contains a copolymer C obtained by polymerizing monomers containing a monomer having a basic functional group and a monomer having a silicone chain, wherein the monomer having a silicone chain has a weight-average molecular weight of 1,000 or more and 10,000 or less, and the copolymer C has a weight-average molecular weight of 10,000 or more and 80,000 or less, and wherein a mass ratio of the monomer having a basic functional group to the monomer having a silicone chain is 3/97 or more and 50/50 or less.

### DETAILED DESCRIPTION OF THE INVENTION

In the recent years, with the increasing demands for speeding up, liquid developers with lowered viscosity are in demand. In other words, liquid developers in which toner particles are stably dispersed at lower viscosity are in demand. In addition, liquid developers having excellent pulverizability, low-temperature fusing ability, and rubbing resistance of the toner are in demand.

The present invention relates to a liquid developer having excellent pulverizability, low-temperature fusing ability, and rubbing resistance while having lowered viscosity, and a method for producing the same.

The liquid developer of the present invention exhibits some effects of having excellent pulverizability, low-temperature fusing ability, and rubbing resistance while having lowered viscosity.

One of the features of the liquid developer of the present invention is in that a liquid developer contains a dispersion of toner particles containing a polyester resin P having a given acid value and a pigment in an insulating liquid in the presence of a dispersant, wherein the dispersant contains a copolymer C obtained by polymerizing monomers containing a monomer having a basic functional group and a monomer having a silicone chain.

Specifically, the dispersant is considered to be appropriately adsorbed to the toner particles because the basic functional group of the dispersant has appropriate affinity with carboxy groups of the polyester resin P. In addition, since the silicone chain in the dispersant has appropriate affinity with the insulating liquid, the toner particles are considered to be dispersed in the insulating liquid via the dispersant. As a result, the liquid developer of the present invention is considered to have excellent pulverizability, low-temperature fusing ability, and rubbing resistance while having lowered viscosity.

The reasons why such effects are exhibited are not elucidated, and they are considered to be as follows.

The lowered viscosity of the liquid developer of the present invention are considered to be due to steric repulsions between the silicone chains themselves of the copolymer C adsorbed to the toner particles.

In addition, the improvements in pulverizability are considered to be due to the binding of carboxy groups of the polyester resin P existing in the new interface of toner particles caused by pulverization and the basic functional groups of the copolymer C which has a high affinity with the carboxy groups, whereby the copolymer C is quickly adsorbed and re-aggregation can be suppressed.

Further, the improvements in low-temperature fusing ability are considered to be due to detachment of the copolymer C from the toner particles and vaporization of the insulating liquid due to heat during fusing, whereby the toner particles themselves are easily aggregated or thermally deposited via the polyester resin P.

In addition, excellent rubbing resistance is considered to be due to the spreading of the copolymer C having a silicone chain which is subject to bleed-out to the surface of the fused images upon fusing, over the fused images.

In the liquid developer of the present invention, the polyester resin P is a resin that serves as a resin binder of the toner particles and has a given acid value.

In the present invention, the acid value of the polyester resin P is 3 mgKOH/g or more, preferably 5 mgKOH/g or more, and more preferably 8 mgKOH/g or more, from the viewpoint of pulverizability, low-temperature fusing ability, and rubbing resistance, and the acid value is 80 mgKOH/g or less, preferably 60 mgKOH/g or less, more preferably 40 mgKOH/g or less, even more preferably 20 mgKOH/g or less, and even more preferably 15 mgKOH/g or less, from the viewpoint of lowered viscosity, low-temperature fusing ability, and rubbing resistance.

The acid value of the polyester resin P can be controlled by adjusting the kinds and compositional ratios of the alcohol component and the carboxylic acid component, an amount of catalyst, and the like, and selecting reaction conditions such as reaction temperature, reaction time, and reaction pressure.

The polyester resin P is obtained by the step including polycondensing an alcohol component and a carboxylic acid component.

The alcohol component includes aliphatic diols, alicyclic diols, aromatic diols, and the like, and the aliphatic diols are preferred, from the viewpoint of lowered viscosity, pulverizability, and rubbing resistance of the toner.

The number of carbon atoms of the aliphatic diol is preferably 2 or more, and more preferably 3 or more, from the viewpoint of improving low-temperature fusing ability of the toner, and the number of carbon atoms is preferably 6 or less, and more preferably 4 or less, from the viewpoint of lowered viscosity, pulverizability, and rubbing resistance.

The aliphatic diol includes ethylene glycol, 1,2-propanediol, 1,3-propanediol, 1,2-butanediol, 1,3-butanediol, 1,4-butanediol, 2,3-butanediol, 1,2-pentanediol, 1,3-pentanediol, 1,4-pentanediol, 1,5-pentanediol, 2,3-pentanediol, 2,4-pentanediol, 1,2-hexanediol, 1,3-hexanediol, 1,4-hexanediol, 1,5-hexanediol, 1,6-hexanediol, 2,3-hexanediol, 3,4-hexanediol, 2,4-hexanediol, 2,5-hexanediol, 1,4-butenediol, neopentyl glycol, and the like.

The aliphatic diol is preferably an aliphatic diol having a hydroxyl group bonded to a secondary carbon atom, from the viewpoint of improving lowered viscosity, pulverizability, and rubbing resistance of the toner. Specific examples include 1,2-propanediol, 1,2-butanediol, 1,3-butanediol, 2,3-butanediol, 1,2-pentanediol, 1,3-pentanediol, 2,3-pentanediol, 2,4-pentanediol, and the like, and 1,2-propanediol and 2,3-butanediol are preferred, and 1,2-propanediol is more preferred.

The content of the aliphatic diol is preferably 50% by mol or more, more preferably 80% by mol or more, even more preferably 90% by mol or more, and even more preferably 95% by mol or more, and preferably 100% by mol or less, more preferably substantially 100% by mol, and even more preferably 100% by mol, of the alcohol component, from the viewpoint of lowered viscosity, pulverizability, and rubbing resistance of the toner. The content of the aliphatic diol having a hydroxyl group bonded to a secondary carbon atom is preferably 80% by mol or more, more preferably 85% by mol or more, even more preferably 90% by mol or more, and even more preferably 95% by mol or more, and preferably 100% by mol or less, more preferably substantially 100% by mol, and even more preferably 100% by mol, of the alcohol component, from the viewpoint of lowered viscosity, pulverizability, and rubbing resistance.

Other alcohol components include aromatic diols such as alkylene oxide adducts of bisphenol A, trihydric or higher polyhydric alcohols such as glycerol, and the like.

It is preferable that the carboxylic acid component contains an aromatic dicarboxylic acid compound, from the viewpoint of pulverizability.

The aromatic dicarboxylic acid compound includes phthalic acid, isophthalic acid, terephthalic acid, or acid anhydrides or alkyl(1 or more and 3 or less carbon atoms) esters thereof. Here, the dicarboxylic acid compound refers to dicarboxylic acids, esters formed between carboxylic acids and an alcohol having 1 or more and 3 or less carbon atoms, or acid anhydrides thereof.

The content of the aromatic dicarboxylic acid compound is preferably 80% by mol or more, more preferably 90% by mol or more, and even more preferably 95% by mol or more, and preferably 100% by mol or less, more preferably substantially 100% by mol, and even more preferably 100% by mol, of the carboxylic acid component, from the viewpoint of pulverizability.

In addition, the carboxylic acid component may contain a tricarboxylic or higher polycarboxylic acid compound, from the viewpoint of improving high-temperature offset resistance, durability and heat-resistant storage property of the toner.

The tricarboxylic or higher polycarboxylic acid compound includes 1,2,4-benzenetricarboxylic acid (trimellitic acid), 2,5,7-naphthalenetricarboxylic acid, 1,2,4,5-benzenetetracarboxylic acid (pyromellitic acid), and the like. From the viewpoint of improving high-temperature offset resistance, durability, and heat-resistance storage property of the toner, 1,2,4-benzenetricarboxylic acid (trimellitic acid) or an acid anhydride thereof is preferred, and an anhydride of 1,2,4-benzenetricarboxylic acid (trimellitic anhydride) is more preferred.

The content of the tricarboxylic or higher polycarboxylic acid compound is preferably 30% by mol or less, more preferably 10% by mol or less, even more preferably 5% by mol or less, and even more preferably 1% by mol or less, and preferably 0% by mol or more, and more preferably 0% by mol, from the viewpoint of lowered viscosity of the toner.

Other carboxylic acid components include aliphatic dicarboxylic acids such as oxalic acid, malonic acid, maleic acid, fumaric acid, succinic acid, adipic acid, sebacic acid, azelaic acid, succinic acids substituted with an alkyl group having 1 or more and 20 or less carbon atoms or an alkenyl group having 2 or more and 20 or less carbon atoms; alicyclic dicarboxylic acids such as cyclohexanedicarboxylic acid; rosins such as unpurified rosins and purified rosins; rosins modified with fumaric acid, maleic acid, acrylic acid, or the like, acid anhydrides thereof, alkyl(1 or more and 3 or less carbon atoms) esters thereof, and the like.

Here, the alcohol component may properly contain a monohydric alcohol, and the carboxylic acid component may properly contain a monocarboxylic acid compound, from the viewpoint of adjusting the softening point of the polyester resin P.

The equivalent ratio of the carboxylic acid component and the alcohol component in the polyester resin P, i.e. COOH group or groups/OH group or groups, is preferably 0.6 or more, and more preferably 0.7 or more, from the viewpoint of reducing an acid value of the polyester resin P, and moreover the equivalent ratio is preferably 1.15 or less, and more preferably 1.10 or less, from the viewpoint of adjusting a softening point of the polyester resin P.

The polycondensation of the alcohol component and the carboxylic acid component can be carried out, for example, in an inert gas atmosphere at a temperature of preferably 180° C. or higher and 250° C. or lower or so, optionally in the presence of an esterification catalyst, an esterification promoter, a polymerization inhibitor or the like. The esterification catalyst includes tin compounds such as dibutyltin oxide and tin(II) 2-ethylhexanoate; titanium compounds such as titanium diisopropylate bistriethanolaminate; and the like. The amount of the esterification catalyst used is preferably 0.01 parts by mass or more, and more preferably 0.1 parts by mass or more, and moreover the amount is preferably 1.5 parts by mass or less, and more preferably 1.0 part by mass or less, based on 100 parts by mass of a total amount of the alcohol component and the carboxylic acid component. The esterification promoter includes gallic acid, and the like. The amount of the esterification promoter used is preferably 0.001 parts by mass or more, and more preferably 0.01 parts by mass or more, and moreover the amount is preferably 0.5 parts by mass or less, and more preferably 0.1 parts by mass or less, based on 100 parts by mass of a total amount of the alcohol component and the carboxylic acid component. The polymerization inhibitor includes tert-butyl catechol, and the like. The amount of the polymerization inhibitor used is preferably 0.001 parts by mass or more, and more preferably 0.01 parts by mass or more, and moreover the amount is preferably 0.5 parts by mass or less, and more preferably 0.1 part by mass or less, based on 100 parts by mass of a total amount of the alcohol component and the carboxylic acid component.

In the present invention, the polyester resin refers to a resin containing a polyester unit formed by polycondensation of the alcohol component and the carboxylic acid component. Therefore, the polyester resin includes a polyester, a polyester-polyamide, a composite resin having two or more kinds of resin components including a polyester component, for example, a hybrid resin in which a polyester component and an addition polymerization-based resin component are partially chemically bonded via a dually reactive monomer, and the like. The content of the polyester unit is preferably 60% by mass or more, more preferably 80% by mass or more, even more preferably 90% by mass or more, and even more preferably 95% by mass or more, and preferably 100% by mass or less, and more preferably 100% by mass, of the polyester resin. The content of the polyester unit in a case where the polyester resin is a composite resin is preferably 60% by mass or more, more preferably 80% by mass or more, even more preferably 90% by mass or more, and even more preferably 95% by mass or more, and preferably less than 100% by mass, and more preferably 99.9% by mass or less, of the composite resin.

Here, the polyester may be a modified polyester to an extent that the properties thereof are not substantially impaired. The modified polyester refers to, for example, a polyester grafted or blocked with a phenol, a urethane, an epoxy or the like according to a method described in Japanese Patent Laid-Open No. Hei-11-133668, Hei-10-239903, Hei-8-20636, or the like.

The softening point of the polyester resin P is preferably 75° C. or higher, more preferably 80° C. or higher, and even more preferably 85° C. or higher, from the viewpoint of improving high-temperature offset resistance, durability, and heat-resistance storage property of the toner, and the softening point is preferably 120° C. or lower, and more preferably 110° C. or lower, from the viewpoint of improving low-temperature fusing ability of the toner.

The softening point of the polyester resin can be controlled by adjusting the kinds and compositional ratios of the alcohol component and the carboxylic acid component, an amount of a catalyst, or the like, or selecting reaction conditions such as reaction temperature, reaction time and reaction pressure.

The glass transition temperature of the polyester resin P is preferably 40° C. or higher, more preferably 43° C. or higher, and even more preferably 45° C. or higher, from the viewpoint of improving durability and heat-resistant storage property, and the glass transition temperature is preferably 70° C. or lower, more preferably 68° C. or lower, and even more preferably 66° C. or lower, from the viewpoint of improving low-temperature fusing ability of the toner.

The glass transition temperature of the polyester resin can be controlled by the kinds and compositional ratios of the alcohol component and the carboxylic acid component, and the like.

The liquid developer of the present invention may contain other resins besides the polyester resin P within the range that would not impair the effects of the present invention. The content of the polyester resin P is preferably 90% by mass or more, and more preferably 95% by mass or more, and preferably 100% by mass or less, more preferably substantially 100% by mass, and even more preferably 100% by mass, of a total amount of resins, and in other words, it is even more preferably to use the polyester resin P alone as the resin. The resins besides the polyester resin P include, for example, polyester resins besides the polyester resin P; styrenic resins which are homopolymers or copolymers of styrene or substituted styrenes, such as polystyrenes, styrene-propylene copolymers, styrene-butadiene copolymers, styrene-vinyl chloride copolymers, styrene-vinyl acetate copolymers, styrene-maleic acid copolymers, styrene-acrylic ester copolymers, and styrene-methacrylic ester copolymers; epoxy resins, rosin-modified maleic resins, polyethylene-based resins, polypropylenes, polyurethanes, silicone resins, phenol resins, aliphatic or alicyclic hydrocarbon resins, and the like.

As the pigment, all the pigments which are used as colorants for toners can be used, and carbon blacks, Phthalocyanine Blue, Permanent Brown FG, Brilliant Fast Scarlet, Pigment Green B, Rhodamine-B Base, Solvent Red 49, Solvent Red 146, Solvent Blue 35, quinacridone, carmine 6B, isoindoline, disazo yellow, or the like can be used. In the present invention, the toner particles may be any one of black toners and color toners.

The content of the pigment based on 100 parts by mass of the polyester resin P is preferably 100 parts by mass or less, more preferably 70 parts by mass or less, even more preferably 50 parts by mass or less, and even more preferably 25 parts by mass or less, from the viewpoint of improving pulverizability of the toner particles to provide particles having smaller particle sizes, from the viewpoint of improving low-temperature fusing ability of the liquid developer, and from the viewpoint of improving dispersion stability of the toner particles in the liquid developer, thereby improving storage stability, and the content is preferably 5 parts by mass or more, more preferably 10 parts by mass or more, and even more preferably 15 parts by mass or more, from the viewpoint of improving the optical density of the liquid developer.

In the present invention, as toner raw materials, an additive such as a releasing agent, a charge control agent, a magnetic particulate, a fluidity improver, an electric conductivity modifier, a reinforcing filler such as a fibrous material, an antioxidant, or a cleanability improver, may be further properly used.

The liquid developer of the present invention is a dispersion of toner particles containing a polyester resin P and a pigment in an insulating liquid in the presence of a dispersant.

In the present invention, the dispersant contains a copolymer C obtained by polymerizing monomers containing a monomer having a basic functional group and a monomer having a silicone chain. The silicone refers to a compound having a polysiloxane backbone.

The basic functional group includes an amino group, an amide group, an imide group, an ammonium salt, and the like. Among them, an amino group is preferred, and a tertiary amino group is more preferred.

It is preferable that the monomer having a basic functional group is a monomer having an amino group represented by the formula (I):

CH₂═C(R³)COYR⁴NR¹R² (I)

wherein each of R¹ and R² is independently a hydrogen atom, or a linear or branched alkyl group having 1 or more and 4 or less carbon atoms, which may be bound to each other to form a ring structure; R³ is a hydrogen atom or a methyl group; R⁴ is a linear or branched alkylene group having 2 or more and 4 or less carbon atoms; and Y is —O— or —NH—, or
an acid neutralized product or a quaternary ammonium salt of this monomer. Preferred acids for obtaining the acid neutralized product include hydrochloric acid, sulfuric acid, nitric acid, acetic acid, formic acid, maleic acid, fumaric acid, citric acid, tartaric acid, adipic acid, sulfamic acid, toluenesulfonic acid, lactic acid, pyrrolidone-2-carboxylic acid, succinic acid, and the like. The quaternary forming agents for obtaining a quaternary ammonium salt include general alkylation agents such as alkyl halides such as methyl chloride, ethyl chloride, methyl bromide, and methyl iodide; and dimethyl sulfate, diethyl sulfate, and di-n-propyl sulfate.

In the formula (I), it is preferable that each of R¹ and R² is independently a linear or branched alkyl group having 1 or more and 4 or less carbon atoms. Specific examples of R¹ and R² include a methyl group, an ethyl group, a propyl group, an isopropyl group, and the like, and a methyl group is preferred.

R⁴ includes an ethylene group, a propylene group, a butylene group, and the like, and an ethylene group is preferred.

Specific examples of a monomer in which R¹ and R² are alkyl groups in the formula (I) (monomer having a tertiary amino group) include (meth)acrylic esters having a dialkylamino group, (meth)acrylamides having a dialkylamino group, and the like. Here, the “(meth)acrylic ester” intends to be acrylic ester, methacrylic ester, or both, and the “(meth)acrylamide” intends to be acrylamide, methacrylamide, or both.

The (meth)acrylic esters having a dialkylamino group include one or more members selected from the group consisting of dimethylaminoethyl (meth)acrylate, diethylaminoethyl (meth)acrylate, dipropylaminoethyl (meth)acrylate, diisopropylaminoethyl (meth)acrylate, dibutylaminoethyl (meth) acrylate, diisobutylaminoethyl (meth)acrylate, and di-t-butylaminoethyl (meth)acrylate, and the like.

The (meth)acrylamides having a dialkylamino group include one or more members selected from the group consisting of dimethylaminopropyl (meth)acrylamide, diethylaminopropyl (meth)acrylamide, dipropylaminopropyl (meth)acrylamide, diisopropylaminopropyl (meth)acrylamide, dibutylaminopropyl (meth)acrylamide, diisobutylaminopropyl (meth)acrylamide, and di-t-butylaminopropyl (meth)acrylamide, and the like.

It is preferable that the monomers having a silicone chain is a silicone-based macro-monomer represented by the formula (II):

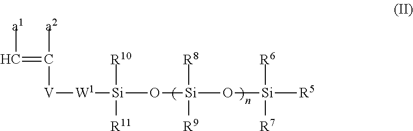

wherein each of a¹ and a², which may be identical or different, is a hydrogen atom, a halogen atom, a cyano group, a hydrocarbon group having 1 or more and 4 or less carbon atoms, —COO—Z¹ or —COO—Z¹ bonded via a divalent hydrocarbon group having 1 or more and 4 or less carbon atoms, wherein Z¹ is a hydrogen atom or a hydrocarbon group which may be substituted; a¹ and a² are preferably a hydrogen atom or a methyl group;

each of R⁵ to R¹¹ is independently an alkyl group having 1 or more and 10 or less carbon atoms, a phenyl group, or an aralkyl group having 7 or more and 16 or less carbon atoms, or an alkoxy group having 1 or more and 10 or less carbon atoms; R⁵ to R¹¹ are preferably an alkyl group having 1 or more and 3 or less carbon atoms, or an alkoxy group having 1 or more and 3 or less carbon atoms, and more preferably a methyl group;

V is —COO—, —COO(CH₂)ₘ—, —OCO—, —OCO(CH₂)ₘ—, —(CH₂)ₖ—OCO—, —(CH₂)ₖ—COO—, —O—, —CONHCOO—, —CONHCO—, —CONH(CH₂)ₘ—, —SO₂—, —CO—, —CONZ²—, —SO₂NZ²—, or a phenylene group, wherein Z² is a hydrogen atom or a hydrocarbon group having 1 or more and 4 or less carbon atoms, m is an integer of 1 or more and 10 or less, and k is an integer of 1 or more and 3 or less; V is preferably —COO— or —COO(CH₂)ₘ—;

atoms such as —C(Z³)(Z⁴)—, —(CH═CH)—, a cyclohexylene group, a phenylene group, —O—, —S—, —C(═O)—, —N(Z⁵)—, —COO—, —SO₂—, —CON(Z⁵)—, —SO₂N(Z⁵)—, —NHCOO—, —NHCONH—, or —Si(Z⁵)(Z⁶)—, or a linking group constituted by any combinations thereof, wherein each of Z³ and Z⁴ is a hydrogen atom, a halogen atom (for example, a fluorine atom, a chlorine atom, a bromine atom, or the like), a cyano group, or a hydroxyl group, and Z⁵ and Z⁶ are the same as Z² defined above; W¹ is preferably —C(Z³)(Z⁴)— or —O—; and
more, and even more preferably 40 or more, and 130 or less, preferably 100 or less, and more preferably 80 or less.

The preferred silicone-based macro-monomer represented by the formula (II) preferably includes, for example, a silicone-based macro-monomer represented by the formula (IIa):

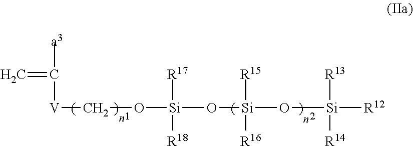

wherein a³ is a hydrogen atom or a methyl group; each of R¹² to R¹⁸ is independently an alkyl group having 1 or more and 10 or less carbon atoms, an alkoxy group having 1 or more and 10 or less carbon atoms, a phenyl group, or —(CH₂)ᵣ—C₆H₅, wherein r is an integer of 1 or more and 10 or less, preferably an alkyl group having 1 or more and 3 or less carbon atoms, and more preferably a methyl group; V¹ is —COO— or —CONH—; n¹ is preferably an integer of 1 or more and 10 or less; n² is an integer of 5 or more, preferably 10 or more, more preferably 30 or more, and even more preferably 40 or more, and 130 or less, preferably 100 or less, and more preferably 80 or less.

The silicone-based macro-monomer represented by the formula (II) can be produced by conventionally known methods of synthesis. The methods include, for example,

(1) a method according to ion polymerization method, including treating a terminal of a living polymer obtained by anion polymerization or cation polymerization with various reagents to provide a macromer;
(2) a method according to a radical polymerization method, including treating an oligomer bound to a terminal reactive group obtained by a radical polymerization using a polymerization initiator and/or chain transfer agent, each containing a reactive group in the molecule, such as a carboxy group, a hydroxy group, and/or an amino group, with various reagents to provide a macromer;
(3) a method according to a poly-addition condensation method, including introducing a polymerizable double-bond group to an oligomer obtained by addition polymerization or polycondensation reaction, in the same manner as in the radical polymerization method; and the like.

Commercially available products of the silicone-based macro-monomer include X-24-8201, X-22-174ASX, X-22-174BX, X-22-174DX, KF-2012, hereinabove, commercially available from Shin-Etsu Chemical Co., Ltd.; FM-0711, FM-0721, FM-0725, hereinabove, commercially available from CHISSO CORPORATION; AK-5, AK-30, AK-32, hereinabove, commercially available from TOAGOSEI CO., LTD., and the like.

The weight-average molecular weight of the monomer having a silicone chain is 1,000 or more, preferably 1,500 or more, more preferably 2,000 or more, even more preferably 3,000 or more, and even more preferably 4,000 or more, from the viewpoint of lowered viscosity, pulverizability, low-temperature fusing ability, and rubbing resistance, and moreover the weight-average molecular weight is 10,000 or less, preferably 8,000 or less, and more preferably 6,000 or less, from the same viewpoint.

The mass ratio of the monomer having a basic functional group to the monomer having a silicone chain is 3/97 or more, preferably 5/95 or more, and more preferably 10/90 or more, from the viewpoint of lowered viscosity and pulverizability, and the mass ratio is 50/50 or less, preferably 40/60 or less, more preferably 30/70 or less, and even more preferably 20/80 or less, from the viewpoint of lowered viscosity, pulverizability, and rubbing resistance.

A total content of the monomer having a basic functional group and the monomer having a silicone chain is preferably 80% by mass or more, more preferably 90% by mass or more, and even more preferably 95% by mass or more, and preferably 100% by mass or less, more preferably substantially 100% by mass, and even more preferably 100% by mass, of the entire monomer usable in the copolymer.

The polymerization of the monomer having a basic functional group and the monomer having a silicone chain can be carried out, for example, by radical polymerization using a polymerization initiator and/or a chain transfer agent.

The weight-average molecular weight of the copolymer C is 80,000 or less, preferably 60,000 or less, more preferably 55,000 or less, and even more preferably 50,000 or less, from the viewpoint of lowered viscosity, low-temperature fusing ability, and rubbing resistance, and the weight-average molecular weight is 10,000 or more, preferably 15,000 or more, and more preferably 18,000 or more, from the viewpoint of lowered viscosity, pulverizability, and low-temperature fusing ability, and even more preferably 30,000 or more, from the viewpoint of low-temperature fusing ability.

The molar ratio of the carboxy group of the polyester resin P to the basic functional group of the copolymer C is preferably 0.5 or more, more preferably 1 or more, even more preferably 1.5 or more, and even more preferably 1.7 or more, from the viewpoint of low-temperature fusing ability, and moreover the molar ratio is preferably 30 or less, more preferably 25 or less, even more preferably 20 or less, even more preferably 15 or less, even more preferably 10 or less, and even more preferably 5 or less, from the viewpoint of pulverizability and lowered viscosity.

The content of the copolymer C, based on 100 parts by mass of the polyester resin P, is preferably 1 part by mass or more, more preferably 2 parts by mass or more, even more preferably 3 parts by mass or more, and even more preferably 4 parts by mass or more, from the viewpoint of pulverizability, lowered viscosity, and rubbing resistance, and moreover the content is preferably 25 parts by mass or less, more preferably 20 parts by mass or less, even more preferably 15 parts by mass or less, even more preferably 10 parts by mass or less, and even more preferably 8 parts by mass or less, from the viewpoint of low-temperature fusing ability.

Although the liquid developer of the present invention may contain a known dispersant besides the copolymer C, the content of the copolymer C is preferably 50% by mass or more, more preferably 70% by mass or more, even more preferably 90% by mass or more, and even more preferably 95% by mass or more, and preferably 100% by mass or less, more preferably substantially 100% by mass, and even more preferably 100% by mass, of the dispersant.

The insulating liquid in the present invention means a liquid through which electricity is less likely to flow, and in the present invention, the conductivity of the insulating liquid is preferably 1.0×10⁻¹⁰ S/m or less, more preferably 5.0×10⁻¹¹ S/m or less, even more preferably 1.0×10⁻¹¹ S/m or less, and even more preferably 5.0×10⁻¹² S/m or less, and moreover the conductivity is preferably 1.0×10⁻¹³ S/m or more. In addition, it is preferable that the insulating liquid has a dielectric constant of 3.5 or less.

Specific examples of the insulating liquid include, for example, hydrocarbon solvents made of aliphatic hydrocarbons, alicyclic hydrocarbons, aromatic hydrocarbons, and halogenated hydrocarbons, polysiloxanes, vegetable oils, and the like, and one or more members selected from the group consisting of the hydrocarbon solvents and polysiloxanes are preferred. Among them, the hydrocarbon solvents are more preferred, from the viewpoint of low-temperature fusing ability, and aliphatic hydrocarbons are even more preferred, from the viewpoint of lowered viscosity and excellent balance between pulverizability, low-temperature fusing ability, and rubbing resistance. The aliphatic hydrocarbons include paraffin-based hydrocarbons, olefins having 12 or more and 18 or less carbon atoms, and the like. These insulating liquids can be used alone or in a combination of two or more kinds. Among the aliphatic hydrocarbons, the paraffin-based hydrocarbons are preferred, from the viewpoint of improving dispersion stability of the toner particles in the liquid developer, thereby improving low-temperature fusing ability of the liquid developer, and from the viewpoint of increasing electric resistance. The paraffin-based hydrocarbons include liquid paraffin, isoparaffin, and the like.

Commercially available products of the aliphatic hydrocarbons include Isopar G, Isopar H, Isopar L, Isopar K, Isopar M, hereinabove commercially available from Exxon Mobile Corporation; ShellSol 71, ShellSol™, hereinabove commercially available from Shell Chemicals Japan Ltd; IP Solvent 1620, IP Solvent 2028, IP Solvent 2835, hereinabove commercially available from Idemitsu Kosan Co., Ltd.; MORESCO WHITE P-55, MORESCO WHITE P-70, MORESCO WHITE P-100, MORESCO WHITE P-150, MORESCO WHITE P-260, hereinabove commercially available from MORESCO Corporation; Cosmo White P-60, Cosmo White P-70, hereinabove commercially available from COSMO OIL LUBRICANTS, CO., LTD.: Lytol commercially available from Sonneborn; Isosol 400 commercially available from JX Nippon Oil & Energy Corporation, LINEALENE 14, LINEALENE 16, LINEALENE 18, LINEALENE 124, LINEALENE 148, LINEALENE 168, hereinabove commercially available from Idemitsu Kosan Co., Ltd.; and the like.

The content of the hydrocarbon solvent, preferably the content of the aliphatic hydrocarbon, is preferably 60% by mass or more, more preferably 80% by mass or more, even more preferably 90% by mass or more, and even more preferably 95% by mass or more, and preferably 100% by mass or less, more preferably substantially 100% by mass, and even more preferably 100% by mass, of the insulating liquid.

The viscosity of the insulating liquid at 25° C. is preferably 100 mPa·s or less, more preferably 50 mPa·s or less, even more preferably 20 mPa·s or less, even more preferably 10 mPa·s or less, and even more preferably 5 mPa·s or less, from the viewpoint of improving developability of the liquid developer, and moreover the viscosity is preferably 1 mPa·s or more, and more preferably 1.5 mPa·s or more, from the viewpoint of improving dispersion stability of the toner particles in the liquid developer. Here, the viscosity of the insulating liquid is measured by a method described in Examples set forth below.

In the present invention, the method for obtaining toner particles includes a method including melt-kneading toner raw materials containing a polyester resin P and a pigment, and pulverizing the melt-kneaded mixture obtained to provide toner particles; a method including mixing an aqueous resin dispersion and an aqueous pigment dispersion, thereby unifying the resin particles and the pigment particles; a method including stirring an aqueous resin dispersion and a pigment at high speed; and the like. The method including melt-kneading toner raw materials, and pulverizing the melt-kneaded mixture obtained is preferred, from the viewpoint of improving developing ability and fusing ability of the liquid developer. From the above viewpoint, it is preferable that the liquid developer of the present invention is produced by a method including:

step 1: melt-kneading at least a polyester resin P and a pigment, and pulverizing a kneaded mixture obtained to provide toner particles; and

step 2: dispersing the toner particles obtained in the step 1 in an insulating liquid in the presence of a dispersant.

In the step 1, at least a polyester resin P and a pigment are melt-kneaded, and a kneaded mixture obtained is pulverized to provide toner particles.

The melt-kneading of the step 1 can be carried out with a known kneader, such as a closed kneader, a single-screw or twin-screw extruder, or an open-roller type kneader. It is preferable that the melt-kneading is carried out with an open-roller type kneader, from the viewpoint of being capable of efficiently and highly dispersing the pigment in the resin, without having to repeat kneading or use a dispersion aid.

It is preferable that a polyester resin P and a pigment are previously mixed with a mixer such as a Henschel mixer or a ball-mill, and thereafter fed to a kneader. In addition, an additive such as a releasing agent or a charge control agent may optionally be fed to be melt-kneaded together with the resin or the like.

The open-roller type kneader refers to a kneader of which kneading unit is an open type, not being tightly closed, and the kneading heat generated during the kneading can be easily dissipated. In addition, it is preferable that a continuous open-roller type kneader is a kneader provided with at least two rollers. The continuous open-roller type kneader usable in the present invention is a kneader provided with two rollers having different peripheral speeds, in other words, two rollers of a high-rotation roller having a high peripheral speed and a low-rotation roller having a low peripheral speed. In the present invention, it is preferable that the high-rotation roller is a heat roller, and that the low-rotation roller is a cooling roller, from the viewpoint of improving dispersibility of the pigment in the resin.

The temperature of the roller can be adjusted by, for example, a temperature of a heating medium passing through the inner portion of the roller, and each roller may be divided in two or more portions in the inner portion of the roller, each being passed through with heating media of different temperatures.

The temperature at the end part of the raw material-supplying side of the high-rotation roller is preferably 70° C. or higher, and more preferably 80° C. or higher, and moreover, the temperature is preferably 160° C. or lower, and more preferably 140° C. or lower, from the viewpoint of reducing mechanical forces during melt-kneading, thereby controlling the generation of heat, and from the viewpoint of improving dispersibility of the pigment in the polyester resin P, and the temperature at the end part of the raw material-supplying side of the low-rotation roller is preferably 20° C. or higher, and more preferably 25° C. or higher, and moreover the temperature is preferably 100° C. or lower, and more preferably 70° C. or lower, from the same viewpoint.

In the high-rotation roller, the difference between setting temperatures of the end part of the raw material-supplying side and the end part of the kneaded mixture-discharging side is preferably 2° C. or more, and moreover preferably 60° C. or less, more preferably 50° C. or less, and even more preferably 30° C. or less, from the viewpoint of preventing detachment of the kneaded mixture from the roller, from the viewpoint of reducing mechanical forces during melt-kneading, thereby controlling the generation of heat, and from the viewpoint of improving dispersibility of the pigment in the polyester resin P. In the low-rotation roller, the difference between setting temperatures of the end part of the raw material-supplying side and the end part of the kneaded mixture-discharging side is preferably 50° C. or less, and more preferably 30° C. or less, and moreover may be preferably 0° C. or more, from the viewpoint of reducing mechanical forces during melt-kneading, thereby controlling the generation of heat, and from the viewpoint of improving dispersibility of the pigment in the polyester resin P.

The peripheral speed of the high-rotation roller is preferably 2 m/min or more, more preferably 10 m/min or more, and even more preferably 25 m/min or more, and moreover preferably 100 m/min or less, more preferably 75 m/min or less, and even more preferably 50 m/min, from the viewpoint of reducing mechanical forces during melt-kneading, thereby controlling the generation of heat, and from the viewpoint of improving dispersibility of the pigment in the polyester resin P. The peripheral speed of the low-rotation roller is preferably 1 m/min or more, more preferably 5 m/min or more, and even more preferably 10 m/min or more, and moreover preferably 90 m/min, more preferably 60 m/min or less, even more preferably 30 m/min or less, and even more preferably 20 m/min or less, from the same viewpoint. In addition, the ratio between the peripheral speeds of the two rollers, i.e., low-rotation roller/high-rotation roller, is preferably 1/10 or more, and more preferably 3/10 or more, and moreover preferably 9/10 or less, and more preferably 8/10 or less.

Structures, size, materials and the like of the roller are not particularly limited. Also, the surface of the roller may be any of smooth, wavy, rugged, or other surfaces. It is preferable that plural spiral ditches are engraved on the surface of each roller, from the viewpoint of reducing mechanical forces during melt-kneading, thereby controlling the generation of heat, and from the viewpoint of improving dispersibility of the pigment in the polyester resin P.

The kneaded mixture obtained by melt-kneading the components is appropriately cooled to an extent of pulverizable hardness, and pulverized.

The pulverizing step may be carried out in divided multi-stages. For example, the resin kneaded mixture may be roughly pulverized to a size of from 1 to 5 mm or so, and the roughly pulverized product may then be further finely pulverized to a desired particle size.

The pulverizer usable in the pulverizing step is not particularly limited. For example, the pulverizer suitably used in the rough pulverization includes a hammer-mill, an atomizer, Rotoplex, and the like. The pulverizer suitably used in the fine pulverization includes an air jet mill, a fluidised bed opposed jet mill, an impact type jet mill, a rotary mechanical mill, and the like.

In the step 1, it is preferable that the toner particles obtained after pulverization are classified as occasion demands.

The classifier usable in the classification step includes an air classifier, a rotor type classifier, a sieve classifier, and the like. The pulverized product which is insufficiently pulverized and removed during the classifying step may be subjected to the pulverizing step again, and the pulverizing step and the classifying step may be repeated as occasion demands.

The volume-median particle size D₅₀ of the toner particles obtained by the step 1 is preferably 3 μm or more, and more preferably 4 μm or more, and moreover preferably 15 μm or less, and more preferably 12 μm or less, from the viewpoint of improving productivity of the wet-milling step described later. Here, the volume-median particle size D₅₀ as used herein means a particle size of which cumulative volume frequency calculated on a volume percentage is 50% counted from the smaller particle sizes.

The step 2 is a step of dispersing the toner particles obtained in the step 1 in an insulating liquid, in the presence of a dispersant.

In the present invention, from the viewpoint of making particle sizes of the toner particles in the liquid developer smaller, and from the viewpoint of lowering viscosity of the liquid developer, it is preferable that the step 2 is carried out by a method including the step 2-1 and the step 2-2 given below.

step 2-1: adding a dispersant in the toner particles obtained in the step 1 to disperse in an insulating liquid to provide a dispersion of the toner particles; and
step 2-2: subjecting the dispersion of the toner particles obtained in the step 2-1 to wet-milling, to provide a liquid developer.

In the step 2-1, it is preferable that a method for mixing toner particles, an insulating liquid, and a dispersant is a method including stirring the components with an agitation mixer, or the like.

The agitation mixer is, but not particularly limited to, preferably high-speed agitation mixers, from the viewpoint of improving productivity and storage stability of the dispersion of toner particles. Specific examples are preferably DESPA commercially available from ASADA IRON WORKS CO., LTD.; T.K. HOMOGENIZING MIXER, T.K. HOMOGENIZING DISPER, T.K. ROBOMIX, hereinabove commercially available from PRIMIX Corporation; CLEARMIX commercially available from M Technique Co., Ltd; KADY Mill commercially available from KADY International, and the like.

The toner particles are previously dispersed by mixing toner particles, an insulating liquid, and a dispersant with a high-speed agitation mixer, whereby a dispersion of toner particles can be obtained, which in turn improves productivity of a liquid developer obtained by the subsequent wet-milling.

The subsequent step 2-2 is a step of wet-milling a dispersion of the toner particles obtained in the step 2-1 to provide a liquid developer. The wet milling refers to a method of subjecting toner particles dispersed in an insulating liquid to a mechanical milling treatment in the state of dispersion in the insulating liquid.

The solid content concentration of the dispersion of toner particles subjected to wet milling is preferably 20% by mass or more, more preferably 30% by mass or more, and even more preferably 33% by mass or more, from the viewpoint of improving optical density of the liquid developer. In addition, the solid content concentration of the dispersion is preferably 50% by mass or less, more preferably 45% by mass or less, and even more preferably 40% by mass or less, from the viewpoint of improving dispersion stability of the toner particles in a liquid developer, thereby improving storage stability. Here, the solid content concentration of the dispersion of toner particles is measured in accordance with a method described in Examples set forth below.

As the apparatus used in the wet-milling, for example, generally used agitation mixers such as anchor blades can be used. The agitation mixers include high-speed agitation mixers such as DESPA commercially available from ASADA IRON WORKS CO., LTD., and T.K. HOMOGENIZING MIXER commercially available from PRIMIX Corporation; pulverizers and kneaders, such as roller mills, bead mills, kneaders, and extruders; and the like. These apparatuses can also be used in a plurality.

Among them, the bead mills are preferably used, from the viewpoint of making particle sizes of the toner particles in a liquid developer smaller, from the viewpoint of improving dispersion stability of the toner particles in a liquid developer, thereby improving storage stability, and from the viewpoint of lowering viscosity of the dispersion of toner particles.

By controlling particle sizes and filling ratios of media used, peripheral speed of rotors, residence time, and the like in the bead mill, toner particles having a desired particle size and a particle size distribution can be obtained.

The solid content concentration of the liquid developer is preferably 10% by mass or more, more preferably 15% by mass or more, and even more preferably 20% by mass or more, from the viewpoint of improving optical density of the liquid developer. Also, the solid content concentration of the liquid developer is preferably 50% by mass or less, more preferably 45% by mass or less, and even more preferably 40% by mass or less, from the viewpoint of improving dispersion stability of the toner particles in the liquid developer, thereby improving storage stability. Here, the solid content concentration of the liquid developer is measured in accordance with a method described in Examples set forth below. After the preparation of the dispersion of toner particles, the solid content concentration of the dispersion of toner particles would be a solid content concentration of the liquid developer unless the dispersion is subjected to such a procedure as dilution or concentration. The dispersion may be diluted with an insulating liquid after wet-milling to adjust the solid content concentration.

The content of the polyester resin P, in the liquid developer of the present invention, is preferably 3% by mass or more, more preferably 5% by mass or more, even more preferably 10% by mass or more, and even more preferably 15% by mass or more, from the viewpoint of improvement in dispersion stability of the toner particles in the liquid developer, and lowered viscosity, and the content is preferably 40% by mass or less, more preferably 30% by mass or less, and even more preferably 25% by mass or less, from the viewpoint of improving pulverizability of the liquid developer. Here, upon the production of a liquid developer, the content of the polyester resin P in the liquid developer as used herein is defined as a content in the liquid developer after the dilution, in a case where the toner particles are dispersed in an insulating liquid and diluted. The same applies hereinafter for the pigment and the copolymer C.

The content of the pigment is preferably 1% by mass or more, more preferably 1.5% by mass or more, and even more preferably 2% by mass or more, of the liquid developer of the present invention, from the viewpoint of improving optical density of the liquid developer, and moreover the content is preferably 10% by mass or less, more preferably 8% by mass or less, and even more preferably 6% by mass or less, from the viewpoint of improvement in dispersion stability of the toner particles in the liquid developer, and lowered viscosity.

The content of the dispersant is preferably 0.05% by mass or more, more preferably 0.1% by mass or more, even more preferably 0.2% by mass or more, and even more preferably 0.3% by mass or more, of the liquid developer of the present invention, from the viewpoint of improvement in dispersion stability of the toner particles in the liquid developer, and lowered viscosity and rubbing resistance, and moreover the content is preferably 8% by mass or less, more preferably 6% by mass or less, and even more preferably 4% by mass or less, from the viewpoint of improving low-temperature fusing ability of the liquid developer.

In addition, the content of the copolymer C is preferably 0.05% by mass or more, more preferably 0.1% by mass or more, even more preferably 0.2% by mass or more, and even more preferably 0.3% by mass or more, of the liquid developer of the present invention, from the viewpoint of improvement in dispersion stability of the toner particles in the liquid developer, and lowered viscosity and rubbing resistance, and moreover the content is preferably 8% by mass or less, more preferably 6% by mass or less, and even more preferably 4% by mass or less, from the viewpoint of improving low-temperature fusing ability of the liquid developer.

The volume-median particle size D₅₀ of the toner particles in the liquid developer is preferably 5 μm or less, more preferably 3 μm or less, and even more preferably 2.5 μm or less, from the viewpoint of making particle sizes of the toner particles smaller and improving image quality of the liquid developer, and moreover the volume-median particle size is preferably 0.5 μm or more, more preferably 1.0 μm or more, and even more preferably 1.5 μm or more, from the viewpoint of lowering the viscosity of the liquid developer. Here, the volume-median particle size D₅₀ of the toner particles in the liquid developer is measured in accordance with a method described in Examples set forth below.

The viscosity of the liquid developer at 25° C. is preferably 40 mPa·s or less, more preferably 30 mPa·s or less, even more preferably 25 mPa·s or less, and even more preferably 20 mPa·s or less, from the viewpoint of improving fusing ability of the liquid developer, and moreover the viscosity is preferably 3 mPa·s or more, more preferably 5 mPa·s or more, even more preferably 7 mPa·s or more, and even more preferably 9 mPa·s or more, from the viewpoint of improving dispersion stability of the toner particles in the liquid developer, thereby improving storage stability. Here, the viscosity of the liquid developer is measured in accordance with a method described in Examples set forth below.

The conductivity of the liquid developer is preferably 1.0×10⁻¹³ S/m or more, more preferably 5.0×10⁻¹³ S/m or more, and even more preferably 1.0×10⁻¹² S/m or more, from the viewpoint of dispersion stability of the toner particles, and moreover the conductivity is preferably 1.0×10⁻¹⁰ S/m or less, more preferably 5.0×10⁻¹¹ S/m or less, and even more preferably 1.0×10⁻¹¹ S/m or less, from the viewpoint of electric chargeability of the toner particles.

With regard to the embodiments described above, the present invention further disclose the following liquid developer and the method for producing the same.

<1> A liquid developer containing a dispersion of toner particles containing a polyester resin P having an acid value of 3 mgKOH/g or more and 80 mgKOH/g or less and a pigment in an insulating liquid in the presence of a dispersant, wherein the dispersant contains a copolymer C obtained by polymerizing monomers containing a monomer having a basic functional group and a monomer having a silicone chain, wherein the monomer having a silicone chain has a weight-average molecular weight of 1,000 or more and 10,000 or less, and the copolymer C has a weight-average molecular weight of 10,000 or more and 80,000 or less, and wherein a mass ratio of the monomer having a basic functional group and the monomer having a silicone chain is 3/97 or more and 50/50 or less.
<2> The liquid developer according to the above <1>, wherein the acid value of the polyester resin P is 5 mgKOH/g or more, preferably 8 mgKOH/g or more, and moreover is 60 mgKOH/g or less, preferably 40 mgKOH/g or less, more preferably 20 mgKOH/g or less, and even more preferably 15 mgKOH/g or less.
<3> The liquid developer according to the above <1> or <2>, wherein the polyester resin P is a resin obtained by polycondensing an alcohol component containing an aliphatic diol and a carboxylic acid component.
<4> The liquid developer according to the above <3>, wherein the aliphatic diol contains an aliphatic diol having a hydroxyl group bonded to a secondary carbon atom.
<5> The liquid developer according to any one of the above <1> to <4>, wherein the polyester resin P is a resin obtained by polycondensing an alcohol component and a carboxylic acid component containing an aromatic dicarboxylic acid compound.
<6> The liquid developer according to any one of the above <1> to <5>, wherein the polyester resin P is a resin obtained by polycondensing an alcohol component containing an aliphatic diol having a hydroxyl group bonded to a secondary carbon atom and a carboxylic acid component containing an aromatic dicarboxylic acid compound.
<7> The liquid developer according to any one of the above <3> to <6>, wherein the number of carbon atoms of the aliphatic diol is 2 or more, preferably 3 or more, and moreover is 6 or less, and preferably 4 or less.
<8> The liquid developer according to any one of the above <3> to <7>, wherein the content of the aliphatic diol is 50% by mol or more, preferably 80% by mol or more, more preferably 90% by mol or more, and even more preferably 95% by mol or more, and 100% by mol or less, preferably substantially 100% by mol, and more preferably 100% by mol, of the alcohol component.
<9> The liquid developer according to any one of the above <4> to <8>, wherein the content of the aliphatic diol having a hydroxyl group bonded to a secondary carbon atom is 80% by mol or more, preferably 90% by mol or more, and more preferably 95% by mol or more, and 100% by mol or less, preferably substantially 100% by mol, and more preferably 100% by mol, of the alcohol component.
<10> The liquid developer according to any one of the above <5> to <9>, wherein the content of the aromatic dicarboxylic acid compound is 80% by mol or more, preferably 90% by mol or more, and more preferably 95% by mol or more, and 100% by mol or less, preferably substantially 100% by mol, and more preferably 100% by mol, of the carboxylic acid component.
<11> The liquid developer according to any one of the above <1> to <10>, wherein the polyester resin P is a resin containing a polyester unit, wherein the content of the polyester unit is preferably 60% by mass or more, more preferably 80% by mass or more, even more preferably 90% by mass or more, and even more preferably 95% by mass or more, and preferably 100% by mass or less, and more preferably 100% by mass, of the polyester resin.
<12> The liquid developer according to any one of the above <1> to <11>, wherein the softening point of the polyester resin P is 75° C. or higher, preferably 80° C. or higher, and more preferably 85° C. or more, and moreover is 120° C. or lower, and preferably 110° C. or lower.
<13> The liquid developer according to any one of the above <1> to <12>, wherein the glass transition temperature of the polyester resin P is 40° C. or higher, preferably 43° C. or higher, and more preferably 45° C. or higher, and moreover is 70° C. or lower, preferably 68° C. or lower, and more preferably 66° C. or lower.
<14> The liquid developer according to any one of the above <1> to <13>, wherein the content of the pigment is 100 parts by mass or less, preferably 70 parts by mass or less, more preferably 50 parts by mass or less, and even more preferably 25 parts by mass or less, and moreover is 5 parts by mass or more, preferably 10 parts by mass or more, and more preferably 15 parts by mass or more, based on 100 parts by mass of the polyester resin P.
<15> The liquid developer according to any one of the above <1> to <14>, wherein the basic functional group is an amino group, and preferably a tertiary amino group.
<16> The liquid developer according to any one of the above <1> to <15>, wherein the monomer having a basic functional group contains a monomer having an amino group represented by the formula (I), or an acid neutralized product or quaternary ammonium salt of this monomer.
<17> The liquid developer according to the above <16>, wherein the monomer having an amino group represented by the formula (I) is a (meth)acrylic ester having a dialkylamino group and/or (meth)acrylamide having a dialkylamino group.
<18> The liquid developer according to the above <17>, wherein the (meth)acrylic ester having a dialkylamino group is one or more members selected from the group consisting of dimethylaminoethyl (meth)acrylate, diethylaminoethyl (meth)acrylate, dipropylaminoethyl (meth)acrylate, diisopropylaminoethyl (meth)acrylate, dibutylaminoethyl (meth)acrylate, diisobutylaminoethyl (meth) acrylate, and di-t-butylaminoethyl (meth)acrylate.
<19> The liquid developer according to the above <17> or <18>, wherein the (meth)acrylamide having a dialkylamino group is one or more members selected from the group consisting of dimethylaminopropyl (meth)acrylamide, diethylaminopropyl (meth)acrylamide, dipropylaminopropyl (meth)acrylamide, diisopropylaminopropyl (meth)acrylamide, dibutylaminopropyl (meth)acrylamide, diisobutylaminopropyl (meth)acrylamide, and di-t-butylaminopropyl (meth)acrylamide.
<20> The liquid developer according to any one of the above <1> to <19>, wherein the monomer having a silicone chain contains a silicone-based macro-monomer represented by the formula (II).
<21> The liquid developer according to any one of the above <1> to <20>, wherein the silicone-based macro-monomer represented by the formula (II) is a silicone-based macro-monomer represented by the formula (IIa).
<22> The liquid developer according to any one of the above <1> to <21>, wherein the weight-average molecular weight of the monomer having a silicone chain is 1,500 or more, preferably 2,000 or more, more preferably 3,000 or more, and even more preferably 4,000 or more, and moreover is 8,000 or less, and preferably 6,000 or less.
<23> The liquid developer according to any one of the above <1> to <22>, wherein the mass ratio of the monomer having a basic functional group to the monomer having a silicone chain is 5/95 or more, and preferably 10/90 or more, and moreover is 40/60 or less, preferably 30/70 or less, and more preferably 20/80 or less.
<24> The liquid developer according to any one of the above <1> to <23>, wherein the weight-average molecular weight of the copolymer C is 60,000 or less, preferably 55,000 or less, and more preferably 50,000 or less, and moreover is 15,000 or more, preferably 18,000 or more, and more preferably 30,000 or more.
<25> The liquid developer according to any one of the above <1> to <24>, wherein the molar ratio of the carboxy groups of the polyester resin P to the basic functional groups of the copolymer C is 0.5 or more, preferably 1 or more, more preferably 1.5 or more, and even more preferably 1.7 or more, and moreover is 30 or less, preferably 25 or less, more preferably 20 or less, even more preferably 15 or less, even more preferably 10 or less, and even more preferably 5 or less.
<26> The liquid developer according to any one of the above <1> to <25>, wherein the content of the copolymer C is 1 part by mass or more, preferably 2 parts by mass or more, more preferably 3 parts by mass or more, and even more preferably 4 parts by mass or more, and moreover is 25 parts by mass or less, preferably 20 parts by mass or less, more preferably 15 parts by mass or less, even more preferably 10 parts by mass or less, and even more preferably 8 parts by mass or less, based on 100 parts by mass of the polyester resin P.
<27> The liquid developer according to any one of the above <1> to <26>, wherein the content of the copolymer C is 50% by mass or more, preferably 70% by mass or more, more preferably 90% by mass or more, and even more preferably 95% by mass or more, and 100% by mass or less, preferably substantially 100% by mass, and more preferably 100% by mass, of the dispersant.
<28> The liquid developer according to any one of the above <1> to <27>, wherein the insulating liquid contains one or more members selected from the group consisting of hydrocarbon solvents and polysiloxanes, preferably hydrocarbon solvents, more preferably aliphatic hydrocarbons, even more preferably paraffin-based hydrocarbons and/or olefins having 12 or more and 18 or less carbon atoms, and even more preferably paraffin-based hydrocarbons.
<29> The liquid developer according to the above <28>, wherein the content of the hydrocarbon solvent, preferably the aliphatic hydrocarbon, is 60% by mass or more, preferably 80% by mass or more, more preferably 90% by mass or more, and even more preferably 95% by mass or more, and 100% by mass or less, preferably substantially 100% by mass, and more preferably 100% by mass, of the insulating liquid.
<30> The liquid developer according to any one of the above <1> to <29>, wherein the content of the polyester resin P is 3% by mass or more, preferably 5% by mass or more, more preferably 10% by mass or more, and even more preferably 15% by mass or more, and moreover is 40% by mass or less, preferably 30% by mass or less, and more preferably 25% by mass or less, of the liquid developer.
<31> The liquid developer according to any one of the above <1> to <30>, wherein the content of the pigment is 1% by mass or more, preferably 1.5% by mass or more, and more preferably 2% by mass or more, and moreover is 10% by mass or less, preferably 8% by mass or less, and more preferably 6% by mass or less, of the liquid developer.
<32> The liquid developer according to any one of the above <1> to <31>, wherein the content of the dispersant is 0.05% by mass or more, preferably 0.1% by mass or more, more preferably 0.2% by mass or more, and even more preferably 0.3% by mass or more, and moreover is 8% by mass or less, preferably 6% by mass or less, and more preferably 4% by mass or less, of the liquid developer.
<33> The liquid developer according to any one of the above <1> to <32>, wherein the content of the copolymer C is 0.05% by mass or more, preferably 0.1% by mass or more, more preferably 0.2% by mass or more, and even more preferably 0.3% by mass or more, and moreover is 8% by mass or less, preferably 6% by mass or less, and more preferably 4% by mass or less, of the liquid developer.
<34> The liquid developer according to any one of the above <1> to <33>, wherein the viscosity of the insulating liquid at 25° C. is 100 mPa·s or less, preferably 50 mPa·s or less, more preferably 20 mPa·s or less, even more preferably 10 mPa·s or less, and even more preferably 5 mPa·s or less, and moreover is 1 mPa·s or more, and preferably 1.5 mPa·s or more.
<35> The liquid developer according to any one of the above <1> to <34>, wherein the viscosity of the liquid developer at 25° C. is 40 mPa·s or less, preferably 30 mPa·s or less, more preferably 25 mPa·s or less, and even more preferably 20 mPa·s or less, and moreover is 3 mPa·s or more, preferably 5 mPa·s or more, more preferably 7 mPa·s or more, and even more preferably 9 mPa·s or more.
<36> The liquid developer according to any one of the above <1> to <35>, wherein the conductivity of the liquid developer is 1.0×10⁻¹³ S/m or more, preferably 5.0×10⁻¹³ S/m or more, and more preferably 1.0×10⁻¹² S/m or more, and moreover is 1.0×10⁻¹⁰ S/m or less, preferably 5.0×10⁻¹¹ S/m or less, and more preferably 1.0×10⁻¹¹ S/m or less.
<37> A method for producing a liquid developer, including:

step 1: melt-kneading at least a polyester resin P having an acid value of 3 mgKOH/g or more and 80 mgKOH/g or less and a pigment, and pulverizing a kneaded mixture obtained to provide toner particles; and

step 2: dispersing the toner particles obtained in the step 1 in an insulating liquid in the presence of a dispersant,

wherein the dispersant contains a copolymer C obtained by polymerizing monomers containing a monomer having a basic functional group and a monomer having a silicone chain, wherein the monomer having a silicone chain has a weight-average molecular weight of 1,000 or more and 10,000 or less, and the copolymer C has a weight-average molecular weight of 10,000 or more and 80,000 or less, and wherein a mass ratio of the monomer having a basic functional group and the monomer having a silicone chain is 3/97 or more and 50/50 or less.
<38> The method for producing a liquid developer according to the above <37>, wherein the melt-kneading in the step 1 is carried out with an open roller-type kneader.
<39> The method for producing a liquid developer according to the above <37> or <38>, wherein the step 2 includes:
step 2-1: adding a dispersant to toner particles obtained in the step 1 to disperse the toner particles in the insulating liquid, to provide a dispersion of toner particles; and
step 2-2: subjecting the dispersion of toner particles obtained in the step 2-1 to wet-milling, to provide a liquid developer.

### EXAMPLES

The following examples further describe and demonstrate embodiments of the present invention. The examples are given solely for the purposes of illustration and are not to be construed as limitations of the present invention. The physical properties of the resins and the like were measured in accordance with the following methods.

### [Softening Point of Resin]

The softening point refers to a temperature at which half of the sample flows out, when plotting a downward movement of a plunger of a flow tester “CFT-500D,” commercially available from Shimadzu Corporation, against temperature, in which a 1 g sample is extruded through a nozzle having a die pore size of 1 mm and a length of 1 mm with applying a load of 1.96 MPa thereto with the plunger, while heating the sample so as to raise the temperature at a rate of 6° C./min.

### [Glass Transition Temperature of Resin]

Measurements are taken using a differential scanning calorimeter “Q20,” commercially available from TA Instruments, Japan, by heating a 0.01 to 0.02 g sample weighed out in an aluminum pan to 200° C. and cooling the sample from that temperature to 0° C. at a cooling rate of 10° C./min. Next, the sample is measured while heating at a rate of 10° C./min. A temperature of an intersection of the extension of the baseline of equal to or lower than the highest temperature of endothermic peak and the tangential line showing the maximum inclination between the kick-off of the peak and the top of the peak in the above measurement is defined as a glass transition temperature.

### [Acid Value of Resin]

The acid value is determined by a method according to JIS K0070 except that only the determination solvent is changed from a mixed solvent of ethanol and ether as prescribed in JIS K0070 to a mixed solvent of acetone and toluene in a volume ratio of acetone:toluene=1:1.

### [Weight-Average Molecular Weight (Mw) of Monomer Having Silicone Chain and Copolymer C]

The weight-average molecular weight (Mw) is obtained by measuring a molecular weight distribution in accordance with a gel permeation chromatography (GPC) method as shown by the following method.

### (1) Preparation of Sample Solution

The monomer having a silicone chain or the copolymer C is dissolved in tetrahydrofuran so as to have a concentration of 0.5 g/100 mL. Next, this solution is filtered with a fluororesin filter “FP-200,” commercially available from Sumitomo Electric Industries, Ltd., having a pore size of 2 μm, to remove insoluble components, to provide a sample solution.

### (2) Measurement of Molecular Weight Distribution

Using the following measurement apparatus and analyzing column, the measurement is taken by allowing tetrahydrofuran to flow through a column as an eluent at a flow rate of 1 mL per minute, and stabilizing the column in a thermostat at 40° C., and loading 100 μL of a sample solution. The molecular weight of the sample is calculated based on the previously drawn calibration curve. At this time, a calibration curve is drawn from several kinds of monodisperse polystyrenes, commercially available from Tosoh Corporation, A-500 (5.0×10²), A-1000 (1.01×10³), A-2500 (2.63×10³), A-5000 (5.97×10³), F-1 (1.02×10⁴), F-2 (1.81×10⁴), F-4 (3.97×10⁴), F-10 (9.64×10⁴), F-20 (1.90×10⁵), F-40 (4.27×10⁵), F-80 (7.06×10⁵), and F-128 (1.09×10⁶) as standard samples.

Measurement Apparatus: HLC-8220GPC, commercially available from Tosoh Corporation
Analyzing Column; GMHLX+G3000HXL, commercially available from Tosoh Corporation.

### [Molar Ratio of Carboxy Groups of Resin to Basic Functional Groups of Dispersant]

The number of moles of carboxy groups of the resin, X, and the number of moles of the basic functional groups of the dispersant, Y, are respectively calculated, and a ratio thereof X/Y is calculated.

$$X = \frac{( \begin{matrix}Mass of Resin , g , \\ in Liquid Developer\end{matrix} ) \times ( \begin{matrix}Acid Value of Resin , \\ mg KOH \text{/} g\end{matrix} )}{56100}$$

$$Y = \frac{\begin{matrix}( \begin{matrix}Mass of Dispersant , g , \\ in Liquid Developer\end{matrix} ) \times \\ ( \begin{matrix}Mass of Monomer Having Basic Functional Group / \\ Total Mass of All Raw Material \\ Monomers Constituting Disperant\end{matrix} )\end{matrix}}{( \begin{matrix}Molecular Weight of Monomer Having \\ Basic Functional Group\end{matrix} )}$$

When plural monomers having a basic functional group are used, Y is calculated for each of the monomers, and a total is taken. The same applies when plural resins are used.

[Volume-Median Particle Size D₅₀ of Toner Particles Before Mixing with

Insulating Liquid]

Measuring Apparatus: Coulter Multisizer II, commercially available from Beckman Coulter, Inc.

### Aperture Diameter: 100

Analyzing Software: Coulter Multisizer AccuComp Ver. 1.19, commercially available from Beckman Coulter, Inc.
Electrolytic Solution: “Isotone II,” commercially available from Beckman Coulter, Inc.
Dispersion: “EMULGEN 109P,” commercially available from Kao Corporation, polyoxyethylene lauryl ether, HLB (Griffin): 13.6, is dissolved in the above electrolytic solution so as to have a concentration of 5% by mass to provide a dispersion.
Dispersion Conditions: Ten milligrams of a measurement sample is added to 5 mL of the above dispersion, and the mixture is dispersed for 1 minute with an ultrasonic disperser, and 25 mL of the above electrolytic solution is added to the dispersion, and further dispersed with an ultrasonic disperser for 1 minute, to prepare a sample dispersion.
Measurement Conditions: The above sample dispersion is added to 100 mL of the above electrolytic solution to adjust to a concentration at which particle sizes of 30,000 particles can be measured in 20 seconds, and thereafter the 30,000 particles are measured, and a volume-median particle size D₅₀ is obtained from the particle size distribution.

### [Conductivity of Insulating Liquid]

A 40 mL glass sample vial “Vial with screw cap, No. 7,” commercially available from Maruemu Corporation is charged with 25 g of an insulating liquid. The conductivity is determined by immersing an electrode, taking 20 measurements for conductivity with a non-aqueous conductivity meter “DT-700,” commercially available from Dispersion Technology, Inc., and calculating an average thereof. The smaller the numerical figures, the higher the resistance.

### [Viscosity at 25° C. of Insulating Liquid and Liquid Developer]

A 6 mL glass sample vial “Vial with screw cap, No. 2,” commercially available from Maruemu Corporation is charged with 4 to 5 mL of a measurement solution, and a viscosity at 25° C. is measured with a torsional oscillation type viscometer “VISCOMATE VM-10A-L,” commercially available from SEKONIC CORPORATION.

### [Solid Content Concentrations of Dispersion of Toner Particles and Liquid Developer]

Ten parts by mass of a sample is diluted with 90 parts by mass of hexane, and the dilution is rotated with a centrifuge “H-201F,” commercially available from KOKUSAN Co., Ltd. at a rotational speed of 25,000 r/min for 20 minutes. After allowing the mixture to stand, the supernatant is removed by decantation, the mixture is then diluted with 90 parts by mass of hexane, and the dilution is again centrifuged under the same conditions as above. The supernatant is removed by decantation, and the lower layer is then dried with a vacuum dryer at 0.5 kPa and 40° C. for 8 hours. The solid content concentration is calculated according to the following formula:

$$\begin{matrix}Solid Content Concentration , \\ \% by Mass\end{matrix} = \frac{Mass of Residues After Drying}{\begin{matrix}Mass of Sample , \\ Corresponding to 10 Parts by Mass Portion\end{matrix}} \times 100$$

### [Volume-Median Particle Size D₅₀ of Toner Particles in Liquid Developer]

A volume-median particle size D₅₀ is determined with a laser diffraction/scattering particle size measurement instrument “Mastersizer 2000,” commercially available from Malvern Instruments, Ltd., by charging a cell for measurement with “Isopar L,” commercially available from Exxon Mobile Corporation, isoparaffin, viscosity at 25° C. of 1 mPa·s, under conditions that a particle refractive index is 1.58, imaginary part being 0.1, and a dispersion medium refractive index is 1.42, at a concentration that gives a scattering intensity of from 5 to 15%.

### Production Example 1 of Resins

### Resins A to C, E, G, and H

A 10-L four-necked flask equipped with a nitrogen inlet tube, a dehydration tube equipped with a fractional distillation tube through which hot water at 98° C. was allowed to flow, a stirrer, and a thermocouple was charged with raw material monomers P as listed in Table 1, and 50 g of an esterification catalyst, i.e. tin(II) 2-ethylhexanoate. The contents were heated to 180° C. and then heated to 210° C. over 5 hours, until a reaction percentage reached 90%, the reaction mixture was further subjected to a reaction at 8.3 kPa, and the reaction was terminated at a point upon reaching an intended softening point, to provide polyester resins having physical properties as shown in Table 1. Here, the reaction percentage as used herein refers to a value calculated by: [amount of generated water in reaction (mol)/theoretical amount of generated water (mol)]×100.

### Production Example 2 of Resin

### Resin D

A 5-L four-necked flask equipped with a nitrogen inlet tube, a dehydration tube, a stirrer, and a thermocouple was charged with 1,567 g of xylene, and the content was heated to 130° C. A liquid mixture of raw material monomers S as listed in Table 1 and 193 g of a polymerization initiator (dibutyl peroxide) was added dropwise thereto at 130° C. over 1.5 hours while stirring, and further held at the same temperature for 1.5 hours to carry out an addition polymerization reaction. The contents were heated to 160° C. and subjected to a reaction for one hour, thereafter heated to 200° C., and held thereat for one hour to remove xylene. The reaction mixture was further subjected to a reaction at 8.3 kPa, to remove the remainder of the xylene, to provide a styrene-acrylic resin having physical properties as shown in Table 1.

### Production Example 3 of Resin

### Resin F

A 10-L four-necked flask equipped with a nitrogen inlet tube, a dehydration tube, a stirrer, and a thermocouple was charged with raw material monomers P as listed in Table 1 and 50 g of an esterification catalyst, i.e. tin(II) 2-ethylhexanoate. The reaction mixture was subjected to a reaction at 235° C., and subjected to a reaction until a reaction percentage reached 90%, the reaction mixture was further subjected to a reaction at 8.3 kPa, and the reaction was terminated at a point upon reaching an intended softening point, to provide a polyester resin having physical properties as shown in Table 1. Here, the reaction percentage as used herein refers to a value calculated by: [amount of generated water in reaction (mol)/theoretical amount of generated water (mol)]×100.

TABLE 1

| | | Resin A | Resin B | Resin C | Resin D | Resin E | Resin F | Resin G | Resin H |
|---|---|---|---|---|---|---|---|---|---|
| Raw Material | 1,2-Propanediol | 3,640 g | 3,426 g | 3,551 g | — | 3,699 g | — | 7,609 g | 2,912 g |
| Monomers P | | (100) | (100) | (100) | | (100) | | (100) | (80) |
| | 1,3-Propanediol | — | — | — | — | — | — | — | 728 g |
| | | | | | | | | | (20) |
| | BPA-PO¹⁾ | — | — | — | — | — | 4,473 g | — | — |
| | | | | | | | (60) | | |
| | BPA-EO²⁾ | — | — | — | — | — | 2,769 g | — | — |
| | | | | | | | (40) | | |
| | Terephthalic Acid | 6,360 g | 5,986 g | 4,654 g | — | 6,301 g | 2,858 g | 1,408 g | 6,360 g |
| | | (80) | (80) | (60) | | (78) | (78) | (39) | (80) |
| | Fumaric | — | — | — | — | — | — | 984 g | — |
| | Acid | | | | | | | (39) | |
| | Trimellitic Anhydride | — | 589 g | 1,794 g | — | — | — | — | — |
| | | | (6.8) | (20) | | | | | |
| Raw Material | Styrene | — | — | — | 3,750 g | — | — | — | — |
| Monomers S | | | | | (84) | | | | |
| | 2-Ethylhexyl Acrylate | — | — | — | 1,250 g | — | — | — | — |
| | | | | | (16) | | | | |
| Physical | Softening Point (° C.) | 87 | 92 | 92 | 100 | 93 | 80 | 88 | 90 |
| Properties | Glass Transition | 47 | 51 | 42 | 45 | 52 | 50 | 49 | 42 |
| of Resin | Temperature (° C.) | | | | | | | | |
| | Acid Value (mgKOH/g) | 10 | 37 | 60 | 0 | 5 | 12 | 7 | 8 |

Note)
The numerical figures inside the parentheses of the raw material monomers P are expressed by a molar ratio when a total amount of alcohol component is defined as 100 mol, and the numerical figures inside the parentheses of the raw material monomers S are expressed by mass ratio.
¹⁾Polyoxypropylene(2.2)-2,2-bis(4-hydroxyphenyl)propane
²⁾Polyoxyethylene(2.2)-2,2-bis(4-hydroxyphenyl)propane

### Production Example 1 of Dispersants

### Dispersants a to j, and l

A 2-L four-necked flask equipped with a reflux condenser, a nitrogen inlet tube, a stirrer, and a thermocouple was charged with a solvent as listed in Table 2, and the internal of the reaction vessel was replaced with nitrogen gas. The internal of the reaction vessel was heated to 80° C., and a mixture of raw material monomers and a polymerization initiator as listed in Table 2 was added dropwise thereto over 2 hours to carry out a polymerization reaction. After the termination of dropwise addition, the reaction mixture was further reacted at 80° C. for 3 hours, and the solvent was distilled off at 80° C., to provide a dispersant having physical properties as shown in Table 2.

### Production Example 2 of Dispersant

### Dispersant k

A 2-L four-necked flask equipped with a reflux condenser, a nitrogen inlet tube, a stirrer, and a thermocouple was charged with a solvent as listed in Table 2, and the internal of the reaction vessel was replaced with nitrogen gas. The internal of the reaction vessel was heated to 110° C., and a mixture of raw material monomers and a polymerization initiator as listed in Table 2 was added dropwise thereto over 2 hours to carry out a polymerization reaction. After the termination of dropwise addition, the reaction mixture was further reacted at 110° C. for 3 hours, and the solvent was distilled off at 110° C., to provide a dispersant having physical properties as shown in Table 2.

| | | Dispersant a | Dispersant b | Dispersant c | Dispersant d | Dispersant e | Dispersant f |
|---|---|---|---|---|---|---|---|
| Solvent | Methyl Ethyl Ketone | 300 g | 300 g | 300 g | 300 g | 300 g | 300 g |
| | Toluene | — | — | — | — | — | — |
| Raw | Dimethylaminoethyl | 48 g | 48 g | 48 g | 48 g | 48 g | 48 g |
| Material | Methacrylate, commercially | | | | | | |
| Monomers | available from Wako Pure | | | | | | |
| | Chemical Industries, Ltd. | | | | | | |
| | X-22-2475, commercially | 252 g | — | — | — | — | — |
| | available from Shin-Etsu | | | | | | |
| | Chemical Co., Ltd., Mw: 750 | | | | | | |
| | X-22-174ASX, commercially | — | 252 g | — | — | — | — |
| | available from Shin-Etsu | | | | | | |
| | Chemical Co., Ltd., Mw: 1,300 | | | | | | |
| | X-22-174BX, commercially | — | — | 252 g | — | — | — |
| | available from Shin-Etsu | | | | | | |
| | Chemical Co., Ltd., Mw: 2,800 | | | | | | |
| | KF-2012, commercially | — | — | — | 252 g | — | 252 g |
| | available from Shin-Etsu | | | | | | |
| | Chemical Co., Ltd., Mw: 5,300 | | | | | | |
| | X-22-2426, commercially | — | — | — | — | 252 g | — |
| | available from Shin-Etsu | | | | | | |
| | Chemical Co., Ltd., Mw: 13,000 | | | | | | |
| Polymerization | 2,2′-Azobis(2,4- | 6 g | 6 g | 6 g | 6 g | 6 g | 9 g |
| Initiator | dimethylvaleronitrile), | | | | | | |
| | commercially available from | | | | | | |
| | Wako Pure Chemical Industries, | | | | | | |
| | Ltd. | | | | | | |
| Mw of Monomer Having Silicone Chain | | 750 | 1,300 | 2,800 | 5,300 | 13,000 | 5,300 |
| Mw of Dispersant | | 30,000 | 33,000 | 40,000 | 49,000 | 58,000 | 20,000 |
| | | Dispersant g | Dispersant h | Dispersant i | Dispersant j | Dispersant k | Dispersant l |
| Solvent | Methyl Ethyl Ketone | 300 g | 300 g | 300 g | 300 g | — | 300 g |
| | Toluene | — | — | — | — | 300 g | — |
| Raw | Dimethylaminoethyl | 48 g | 180 g | 150 g | 15 g | 48 g | 48 g |
| Material | Methacrylate, commercially | | | | | | |
| Monomers | available from Wako Pure | | | | | | |
| | Chemical Industries, Ltd. | | | | | | |
| | X-22-2475, commercially | — | — | — | — | — | — |
| | available from Shin-Etsu | | | | | | |
| | Chemical Co., Ltd., Mw: 750 | | | | | | |
| | X-22-174ASX, commercially | — | — | — | — | — | — |
| | available from Shin-Etsu | | | | | | |
| | Chemical Co., Ltd., Mw: 1,300 | | | | | | |
| | X-22-174BX, commercially | — | — | — | — | — | — |
| | available from Shin-Etsu | | | | | | |
| | Chemical Co., Ltd., Mw: 2,800 | | | | | | |
| | KF-2012, commercially | 252 g | 120 g | 150 g | 285 g | 252 g | 252 g |
| | available from Shin-Etsu | | | | | | |
| | Chemical Co., Ltd., Mw: 5,300 | | | | | | |
| | X-22-2426, commercially | — | — | — | — | — | — |
| | available from Shin-Etsu | | | | | | |
| | Chemical Co., Ltd., Mw: 13,000 | | | | | | |
| Polymerization | 2,2′-Azobis(2,4- | 2 g | 9 g | 9 g | 9 g | 27 g | 3 g |
| Initiator | dimethylvaleronitrile), | | | | | | |
| | commercially available from | | | | | | |
| | Wako Pure Chemical Industries, | | | | | | |
| | Ltd. | | | | | | |

| | | | | | | |
|---|---|---|---|---|---|---|
| Mw of Monomer Having Silicone Chain | 5,300 | 5,300 | 5,300 | 5,300 | 5,300 | 5,300 |
| Mw of Dispersant | 90,000 | 20,000 | 23,000 | 30,000 | 8,500 | 78,000 |

Resins as listed in any one of Tables 4 to 6 in an amount of 85 parts by mass each, and 15 parts by mass of a pigment “ECB-301,” commercially available from DAINICHISEIKA COLOR & CHEMICALS MFG. CO., LTD., Phthalocyanine Blue 15:3, were previously mixed with a 20-L Henschel mixer while stirring for 3 minutes at 1,500 r/min (21.6 m/sec), and the mixture was melt-kneaded under the conditions given below.

### [Melt-Kneading Conditions]

A continuous twin open-roller type kneader “Kneadex,” commercially available from MITSUI MINING COMPANY, LIMITED having an outer diameter of roller of 14 cm and an effective length of roller of 53 cm was used. The operating conditions of the continuous twin open-roller type kneader were a rotational speed of a high-rotation roller (front roller) of 75 r/min (peripheral speed 32.4 m/min), a rotational speed of a low-rotation roller (back roller) of 35 r/min (peripheral speed 15.0 m/min), and a gap between the rollers at an end of the raw material supplying side of 0.1 mm. The temperatures of the heating medium and the cooling medium inside the rollers were as follows. The high-rotation roller had a temperature at the raw material supplying side of 90° C., and a temperature at the kneaded mixture-discharging side of 85° C., and the low-rotation roller had a temperature at the raw material supplying side of 35° C., and a temperature at the kneaded mixture-discharging side of 35° C. In addition, the feeding rate of the raw material mixture to the kneader was 10 kg/h, and the average residence time in the kneader was about 3 minutes.

The kneaded mixture obtained above was roll-cooled with a cooling roller, and the cooled product was roughly pulverized to a size of 1 mm or so with a hammer-mill, and then finely pulverized and classified with an air jet type jet mill “IDS,” commercially available from Nippon Pneumatic Mfg. Co., Ltd., to provide toner particles having a volume-median particle size D₅₀ of 10 μm.

A 2-L polyethylene vessel was charged with 115.5 g of toner particles obtained, 211 g of an insulating liquid as listed in Tables 4 to 6, and a dispersant listed in Tables 4 to 6, and the contents were stirred with “T.K. ROBOMIX,” commercially available from PRIMIX Corporation, under ice-cooling at a rotational speed of 7,000 r/min for 30 minutes, to provide a dispersion of toner particles having a solid content concentration of from 36 to 40% by mass.

The dispersion of toner particles obtained was subjected to wet milling for 4 hours with 6 vessels-type sand grinder “TSG-6,” commercially available from AIMEX CO., LTD., at a rotational speed of 1,300 r/min (4.8 m/sec) using zirconia beads having a diameter of 0.8 mm at a volume filling ratio of 60% by volume. The beads were filtered off, and the filtrate was diluted with the insulating liquid so as to adjust its solid content concentration to 25% by mass, to provide a liquid developer having viscosity as shown in Tables 4 to 6.

The details of the insulating liquids used in Examples and Comparative Examples are listed in Table 3.

TABLE 3

| | Viscosity | | |
|---|---|---|---|
| | at 25° C., | Conductivity, | Chemical |
| Seller (Manufacturer) | mPa · s | S/m | Name |
| Isopar M, commercially | 2.7 | 5.08 × 10⁻¹³ | Isoparaffin |
| available from Exxon | | | |
| Mobile Corporation | | | |
| LINEALENE 16, | 2.3 | 9.43 × 10⁻¹³ | C16 α-olefin |
| commercially | | | (1-Hexadecene) |
| available from | | | |
| Idemitsu Kosan Co., Ltd. | | | |
| KF-96L-2cs, commercially | 1.8 | 1.10 × 10⁻¹² | Dimethyl |
| available from Shin-Etsu | | | Polysiloxane |
| Chemical Co., Ltd. | | | |
| KF-96L-5cs, commercially | 4.8 | 1.40 × 10⁻¹² | Dimethyl |
| available from Shin-Etsu | | | Polysiloxane |
| Chemical Co., Ltd. | | | |

### Test Example 1

### Pulverizability

The pulverizability was evaluated from a value of a volume-median particle size D₅₀ of the toner particles in the liquid developer, i.e. a volume-median particle size D₅₀ of the toner particles after being wet-milled for 4 hours in the production process of the liquid developer. The results are shown in Tables 4 to 6. The smaller the volume-median particle size, the more excellent the pulverizability, in other words dispersion properties of the dispersant. The value for the volume-median particle size is preferably 3.3 μm or less, more preferably 3.0 μm or less, and even more preferably 2.5 μm or less.

### Test Example 2

### Low-Temperature Fusing Ability

A liquid developer was dropped on a blank paper sheet “OK Kinfuji,” commercially available from Oji Paper Co., Ltd., basis weight: 84.9 g/m², paper thickness: 75 μm, and dried with a wire bar so as to produce a thin film having a weight of 1.2 g/m² on a dry basis.

The produced thin film was kept in a thermostat at 80° C. for 10 seconds, and thereafter fused at a fusing speed of 280 mm/sec, with an external fuser taken out of the fusing apparatus of “OKI MICROLINE 3010,” commercially available from Oki Data Corporation, the fusing roller of which was set at 80° to 160° C.

The resulting fused images were adhered to a mending tape “Scotch Mending Tape 810,” commercially available from 3M, width of 18 mm, the tape was pressed with a roller so as to have a load of 500 g being applied thereto, and the tape was removed. The optical densities before and after tape removal were measured with a colorimeter “GretagMacbeth Spectroeye,” commercially available from Gretag. The fused image-printed portions were measured at 3 points each, and an average thereof was calculated as an optical density. A fusing ratio (%) was calculated from a value obtained by [optical density after removal]/[optical density before removal]×100, to evaluate fusing ability where a temperature at which fusing ratio is 90% or more is defined as the lowest fusing temperature. The results are shown in Tables 4 to 6. The lower the lowest fusing temperature, the more excellent the fusing ability, and the lowest fusing temperature is preferably 120° C. or lower, more preferably 110° C. or lower, and even more preferably 105° C. or lower.

### Test Example 3

### Rubbing Resistance

A blank paper sheet “OK Kinfuji,” commercially available from Oji Paper Co., Ltd., basis weight: 84.9 g/m², paper thickness: 75 μm, was wound around a 500 g weight of which bottom had dimensions of 20 mm×20 mm, and placed over the printouts that were fused at the lowest fusing temperature in Test Example 2 so that the paper sheets would be rubbing against each other, and rubbings with a width of 10 cm were reciprocated 10 times. Thereafter the paper was removed from the weight, an average of 3 points of optical densities of the rubbed portions was obtained as Da, an average of 3 points of optical densities of non-rubbed portions was obtained Db, and a difference ΔD (Db−Da) was calculated. The results are shown in Tables 4 to 6. The smaller the ΔD, the more excellent the paper rubbing resistance, in other words the rubbing resistance. The ΔD value is preferably 0.50 or less, more preferably 0.30 or less, and even more preferably 0.10 or less.

### Test Example 4

### Electroconductivity

A 40 mL glass sample vial “Vial with screw cap, No. 7,” commercially available from Maruemu Corporation was charged with 25 g of a liquid developer. The conductivity was determined by immersing an electrode, taking measurements 20 times for conductivity with a non-aqueous conductivity meter “DT-700,” commercially available from Dispersion Technology, and calculating an average thereof. The results are shown in Tables 4 to 6. The smaller the numerical figures, the higher the resistance.

TABLE 4

| | | Ex. 1 | Ex. 2 | Ex. 3 | Ex. 4 | Ex. 5 |
|---|---|---|---|---|---|---|
| Toner | Resin - Polyester Resin P | Resin A | Resin A | Resin A | Resin A | Resin A |
| Particles | Acid Value of Resin - Polyester Resin | 10 | 10 | 10 | 10 | 10 |
| 115.5 g | P, mgKOH/g | | | | | |
| Insulating | Insulating Liquid | Isopar M | Isopar M | Isopar M | Isopar M | Isopar M |
| Liquid | Viscosity of Insulating Liquid, mPa · s | 2.7 | 2.7 | 2.7 | 2.7 | 2.7 |
| 211 g | | | | | | |
| Dispersant | Dispersant - Copolymer C | Dispersant b | Dispersant c | Dispersant d | Dispersant f | Dispersant i |
| | Amount of Dispersant -Copolymer C | 3.47 | 3.47 | 3.47 | 3.47 | 3.47 |
| | Used, g | | | | | |
| | Mass Ratio of Monomers Having | 16/84 | 16/84 | 16/84 | 16/84 | 50/50 |
| | Basic Functional Groups to Monomers | | | | | |
| | Having Silicone Chain | | | | | |
| | Mw of Monomers Having Silicone | 1,300 | 2,800 | 5,300 | 5,300 | 5,300 |
| | Chain | | | | | |
| | Mw of Dispersant - Copolymer C | 33,000 | 40,000 | 49,000 | 20,000 | 23,000 |
| Parts by Mass of Dispersant, Copolymer C, Based on | | 3.53 | 3.53 | 3.53 | 3.53 | 3.53 |
| 100 Parts by Mass of Resin, Polyester Resin P | | | | | | |
| Molar Ratio of Carboxy Groups of Resin, Polyester | | 4.95 | 4.95 | 4.95 | 4.95 | 1.58 |
| Resin P to Basic Functional Groups of Dispersant, | | | | | | |
| Copolymer C | | | | | | |
| Evaluation | Viscosity, mPa · s | 15 | 16 | 13 | 10 | 15 |
| of Liquid | Pulverizability, Particle Size, μm | 2.7 | 2.1 | 2.6 | 2.0 | 2.9 |
| Developer | Low-Temperature Fusing Ability, | 100 | 100 | 100 | 110 | 110 |
| | Lowest Fusing Temperature, ° C. | | | | | |
| | Rubbing Resistance ΔD | 0.30 | 0.16 | 0.05 | 0.06 | 0.13 |
| | Electroconductivity, Conductivity, S/m | 3.0 × 10⁻¹¹ | 4.0 × 10⁻¹¹ | 4.5 × 10⁻¹¹ | 6.3 × 10⁻¹¹ | 2.7 × 10⁻¹¹ |

| | | Ex. 6 | Ex. 7 | Ex. 8 | Ex. 9 |
|---|---|---|---|---|---|
| Toner | Resin - Polyester Resin P | Resin A | Resin B | Resin C | Resin E |
| Particles | Acid Value of Resin - Polyester Resin | 10 | 37 | 60 | 5 |
| 115.5 g | P, mgKOH/g | | | | |
| Insulating | Insulating Liquid | Isopar M | Isopar M | Isopar M | Isopar M |
| Liquid | Viscosity of Insulating Liquid, mPa · s | 2.7 | 2.7 | 2.7 | 2.7 |
| 211 g | | | | | |
| Dispersant | Dispersant - Copolymer C | Dispersant j | Dispersant d | Dispersant d | Dispersant d |
| | Amount of Dispersant -Copolymer C | 3.47 | 3.47 | 3.47 | 3.47 |
| | Used, g | | | | |
| | Mass Ratio of Monomers Having | 5/95 | 16/84 | 16/84 | 16/84 |
| | Basic Functional Groups to Monomers | | | | |
| | Having Silicone Chain | | | | |
| | Mw of Monomers Having Silicone | 5,300 | 5,300 | 5,300 | 5,300 |
| | Chain | | | | |
| | Mw of Dispersant - Copolymer C | 30,000 | 49,000 | 49,000 | 49,000 |
| Parts by Mass of Dispersant, Copolymer C, Based on | | 3.53 | 3.53 | 3.53 | 3.53 |
| 100 Parts by Mass of Resin, Polyester Resin P | | | | | |
| Molar Ratio of Carboxy Groups of Resin, Polyester | | 15.84 | 18.31 | 29.69 | 2.47 |
| Resin P to Basic Functional Groups of Dispersant, | | | | | |
| Copolymer C | | | | | |
| Evaluation | Viscosity, mPa · s | 19 | 24 | 29 | 13 |
| of Liquid | Pulverizability, Particle Size, μm | 2.9 | 2.5 | 2.2 | 2.9 |
| Developer | Low-Temperature Fusing Ability, | 110 | 120 | 110 | 120 |
| | Lowest Fusing Temperature, ° C. | | | | |
| | Rubbing Resistance ΔD | 0.05 | 0.08 | 0.10 | 0.15 |
| | Electroconductivity, Conductivity, S/m | 9.5 × 10⁻¹⁰ | 5.3 × 10⁻¹⁰ | 7.2 × 10⁻¹⁰ | 4.8 × 10⁻¹¹ |

TABLE 5

| | | Ex. 10 | Ex. 11 | Ex. 12 | Ex. 13 | Ex. 14 |
|---|---|---|---|---|---|---|
| Toner | Resin - Polyester Resin P | Resin F | Resin A | Resin A | Resin A | Resin A |
| Particles | Acid Value of Resin - Polyester Resin | 12 | 10 | 10 | 10 | 10 |
| 115.5 g | P, mgKOH/g | | | | | |
| Insulating | Insulating Liquid | Isopar M | Isopar M | Isopar M | Isopar M | Isopar M |
| Liquid | Viscosity of Insulating Liquid, mPa · s | 2.7 | 2.7 | 2.7 | 2.7 | 2.7 |
| 211 g | | | | | | |
| Dispersant | Dispersant - Copolymer C | Dispersant d | Dispersant d | Dispersant d | Dispersant d | Dispersant d |
| | Amount of Dispersant -Copolymer C | 3.47 | 5.78 | 11.55 | 23.1 | 1 |
| | Used, g | | | | | |
| | Mass Ratio of Monomers Having | 16/84 | 16/84 | 16/84 | 16/84 | 16/84 |
| | Basic Functional Groups to Monomers | | | | | |
| | Having Silicone Chain | | | | | |
| | Mw of Monomers Having Silicone | 5,300 | 5,300 | 5,300 | 5,300 | 5,300 |
| | Chain | | | | | |
| | Mw of Dispersant - Copolymer C | 49,000 | 49,000 | 49,000 | 49,000 | 49,000 |
| Parts by Mass of Dispersant, Copolymer C, Based on | | 3.53 | 5.89 | 11.76 | 23.53 | 1.02 |
| 100 Parts by Mass of Resin, Polyester Resin P | | | | | | |
| Molar Ratio of Carboxy Groups of Resin, Polyester | | 5.94 | 2.97 | 1.49 | 0.74 | 17.17 |
| Resin P to Basic Functional Groups of Dispersant, | | | | | | |
| Copolymer C | | | | | | |
| Evaluation | Viscosity, mPa · s | 15 | 11 | 10 | 9 | 28 |
| of Liquid | Pulverizability, Particle Size, μm | 2.9 | 2.4 | 2.2 | 2.6 | 2.9 |
| Developer | Low-Temperature Fusing Ability, | 100 | 100 | 110 | 120 | 100 |
| | Lowest Fusing Temperature, ° C. | | | | | |
| | Rubbing Resistance ΔD | 0.06 | 0.05 | 0.05 | 0.05 | 0.18 |
| | Electroconductivity, Conductivity, S/m | 8.5 × 10⁻¹¹ | 1.2 × 10⁻¹⁰ | 7.4 × 10⁻¹⁰ | 9.0 × 10⁻¹⁰ | 2.0 × 10⁻¹¹ |
| | | Ex. 15 | Ex. 16 | Ex. 17 | Ex. 18 | Ex. 19 |
| Toner | Resin - Polyester Resin P | Resin A | Resin A | Resin A | Resin G | Resin H |
| Particles | Acid Value of Resin - Polyester Resin | 10 | 10 | 10 | 7 | 8 |
| 115.5 g | P, mgKOH/g | | | | | |
| Insulating | Insulating Liquid | Isopar M | LINEA- | KF-96L-2cs/ | Isopar M | Isopar M |
| Liquid | | | LENE 16 | KF-96L- | | |
| 211 g | | | | 5cs = 60/40 | | |
| | Viscosity of Insulating Liquid, mPa · s | 2.7 | 2.3 | 3.0 | 2.7 | 2.7 |
| | | | | (weighted- | | |
| | | | | average) | | |
| Dispersant | Dispersant - Copolymer C | Dispersant l | Dispersant d | Dispersant d | Dispersant d | Dispersant d |
| | Amount of Dispersant -Copolymer C | 3.47 | 3.47 | 3.47 | 3.47 | 3.47 |
| | Used, g | | | | | |
| | Mass Ratio of Monomers Having | 16/84 | 16/84 | 16/84 | 16/84 | 16/84 |
| | Basic Functional Groups to Monomers | | | | | |
| | Having Silicone Chain | | | | | |
| | Mw of Monomers Having Silicone | 5,300 | 5,300 | 5,300 | 5,300 | 5,300 |
| | Chain | | | | | |
| | Mw of Dispersant - Copolymer C | 78,000 | 49,000 | 49,000 | 49,000 | 49,000 |
| Parts by Mass of Dispersant, Copolymer C, Based on | | 3.53 | 3.53 | 3.53 | 3.53 | 3.53 |
| 100 Parts by Mass of Resin, Polyester Resin P | | | | | | |
| Molar Ratio of Carboxy Groups of Resin, Polyester | | 4.95 | 4.95 | 4.95 | 3.46 | 3.96 |
| Resin P to Basic Functional Groups of Dispersant, | | | | | | |
| Copolymer C | | | | | | |
| Evaluation | Viscosity, mPa · s | 26 | 12 | 16 | 13 | 26 |
| of Liquid | Pulverizability, Particle Size, μm | 2.4 | 2.5 | 3.2 | 2.8 | 3.0 |
| Developer | Low-Temperature Fusing Ability, | 110 | 120 | 120 | 100 | 110 |
| | Lowest Fusing Temperature, ° C. | | | | | |
| | Rubbing Resistance ΔD | 0.07 | 0.08 | 0.05 | 0.05 | 0.08 |
| | Electroconductivity, Conductivity, S/m | 2.5 × 10⁻¹¹ | 6.3 × 10⁻¹¹ | 8.9 × 10⁻¹¹ | 7.1 × 10⁻¹¹ | 4.0 × 10⁻¹¹ |

TABLE 6

| | | Comp. | Comp. | Comp. | Comp. | Comp. | Comp. |
|---|---|---|---|---|---|---|---|
| | | Ex. 1 | Ex. 2 | Ex. 3 | Ex. 4 | Ex. 5 | Ex. 6 |
| Toner | Resin | Resin A | Resin A | Resin A | Resin A | Resin A | Resin D |
| Particles | Acid Value of Resin, mgKOH/g | 10 | 10 | 10 | 10 | 10 | 0 |
| 115.5 g | | | | | | | |
| Insulating | Insulating Liquid | Isopar M | Isopar M | Isopar M | Isopar M | Isopar M | Isopar M |
| Liquid | Viscosity of Insulating Liquid, mPa · s | 2.7 | 2.7 | 2.7 | 2.7 | 2.7 | 2.7 |
| 211 g | | | | | | | |
| Dispersant | Dispersant | Dispersant a | Dispersant e | Dispersant g | Dispersant k | Dispersant h | Dispersant d |
| | Amount of Dispersant Used, g | 3.47 | 3.47 | 3.47 | 3.47 | 3.47 | 3.47 |
| | Mass Ratio of Monomers Having Basic | 16/84 | 16/84 | 16/84 | 16/84 | 60/40 | 16/84 |
| | Functional Groups to Monomers Having | | | | | | |
| | Silicone Chain | | | | | | |
| | Mw of Monomers Having Silicone | 750 | 13,000 | 5,300 | 5,300 | 5,300 | 5,300 |
| | Chain | | | | | | |
| | Mw of Dispersant | 30,000 | 58,000 | 90,000 | 8,500 | 20,000 | 49,000 |
| Parts by Mass of Dispersant, Based on 100 Parts by | | 3.53 | 3.53 | 3.53 | 3.53 | 3.53 | 3.53 |
| Mass of Resin | | | | | | | |
| Molar Ratio of Carboxy Groups of Resin to Basic | | 4.95 | 4.95 | 4.95 | 4.95 | 1.32 | — |
| Functional Groups of Dispersant | | | | | | | |
| Evaluation | Viscosity, mPa · s | 23 | Unable to | 32 | 43 | 18 | Unable to |
| of Liquid | Pulverizability, Particle Size, μm | 3.5 | evaluate, | 2.5 | 3.8 | 3.5 | evaluate, |
| Developer | Low-Temperature Fusing Ability, | 120 | due to | 110 | 130 | 110 | due to |
| | Lowest Fusing Temperature, ° C. | | solidification | | | | solidification |
| | Rubbing Resistance ΔD | 1.00 | | 0.07 | 0.10 | 0.53 | |
| | Electroconductivity, Conductivity, S/m | 5.6 × 10⁻¹¹ | | 3.4 × 10⁻¹¹ | 2.3 × 10⁻⁹ | 3.5 × 10⁻¹¹ | |

In the comparisons between Examples 1 to 3 and Comparative Examples 1 and 2, it can be seen that Example 3 where the monomers having a silicone chain have a weight-average molecular weight of 5,300 has an even lowered viscosity, and excellent rubbing resistance.

In the comparisons between Examples 3, 4, and 15 and Comparative Examples 3 and 4, it can be seen that Example 3 where the dispersant has a weight-average molecular weight of 49,000 has more excellent low-temperature fusing ability and rubbing resistance, and that Example 4 where the dispersant has a weight-average molecular weight of 20,000 has an even lowered viscosity and excellent pulverizability.

In the comparisons between Examples 4 to 6 and Comparative Example 5, it can be seen that Example 4 where the mass ratio of the monomers having a silicone chain to the monomers having basic functional groups is 84/16 has an even lowered viscosity, and excellent pulverizability, low-temperature fusing ability, and rubbing resistance.

In the comparisons between Examples 3, 7 to 9 and Comparative Example 6, it can be seen that Example 3 where the acid value of the polyester resin is 10 mgKOH/g has an even lowered viscosity, and excellent low-temperature fusing ability, pulverizability, and rubbing resistance.

In the comparisons between Examples 3 and 10, it can be seen that Example 3 where the alcohol component of the polyester resin contains an aliphatic diol having a hydroxyl group bonded to a secondary carbon atom in an amount of 80% by mol or more has an even lowered viscosity, and excellent pulverizability and rubbing resistance.

In the comparisons of Examples 3 and 11 to 14, it can be seen that Example 11 where the amount of the dispersant is 5.89 parts by mass based on 100 parts by mass of the polyester resin has more excellent balance between lowered viscosity, pulverizability, low-temperature fusing ability, and rubbing resistance.

In the comparisons of Examples 3 and 18, it can be seen that Example 3 where the carboxylic acid component of the polyester resin contains an aromatic dicarboxylic compound in an amount of 80% by mol or more has more excellent pulverizability.

In the comparisons of Examples 3, 16, and 17, it can be seen that Example 3 where the insulating liquid is a paraffin-based hydrocarbon has more excellent balance between low-temperature fusing ability, lowered viscosity, pulverizability, and rubbing resistance.

In the comparisons of Examples 3 and 19, it can be seen that the one having a higher content of the aliphatic diol having a hydroxyl group bonded to a secondary carbon atom in the alcohol component has an even lowered viscosity, and excellent low-temperature fusing ability, pulverizability, and rubbing resistance.

The liquid developer of the present invention can be suitably used in development of latent images formed in, for example, an electrophotographic method, an electrostatic recording method, an electrostatic printing method, or the like.

What is claimed is:

1. A liquid developer comprising a dispersion of toner particles comprising a polyester resin P having an acid value of 3 mgKOH/g or more and 80 mgKOH/g or less and a pigment in an insulating liquid in the presence of a dispersant, wherein the dispersant comprises a copolymer C obtained by polymerizing monomers comprising a monomer having a basic functional group and a monomer having a silicone chain, wherein the monomer having a silicone chain has a weight-average molecular weight of 1,000 or more and 10,000 or less, and the copolymer C has a weight-average molecular weight of 10,000 or more and 80,000 or less, and wherein a mass ratio of the monomer having a basic functional group to the monomer having a silicone chain is 3/97 or more and 50/50 or less.

2. The liquid developer according to claim 1, wherein the content of the copolymer C is 1 part by mass or more and 25 parts by mass or less, based on 100 parts by mass of the polyester resin P.

3. The liquid developer according to claim 1, wherein the basic functional group is an amino group.

4. The liquid developer according to claim 1, wherein the monomer having a basic functional group comprises a monomer having an amino group represented by the formula (I):
CH₂═C(R³)COYR⁴NR¹R² (I)
wherein each of R¹ and R² is independently a hydrogen atom, or a linear or branched alkyl group having 1 or more and 4 or less carbon atoms, which may be bound to each other to form a ring structure; R³ is a hydrogen atom or a methyl group; R⁴ is a linear or branched alkylene group having 2 or more and 4 or less carbon atoms; and Y is —O— or —NH—, or
an acid neutralized product or a quaternary ammonium salt of this monomer.

5. The liquid developer according to claim 4, wherein the monomer having an amino group represented by the formula (I) is a (meth)acrylic ester having a dialkylamino group and/or (meth)acrylamide having a dialkylamino group.

6. The liquid developer according to claim 1, wherein the monomer having a silicone chain comprises a silicone-based macro-monomer represented by the formula (II): 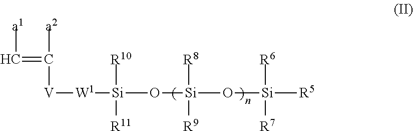
wherein each of a¹ and a², which may be identical or different, is a hydrogen atom, a halogen atom, a cyano group, a hydrocarbon group having 1 or more and 4 or less carbon atoms, —COO—Z¹ or —COO—Z¹ bonded via a divalent hydrocarbon group having 1 or more and 4 or less carbon atoms, wherein Z¹ is a hydrogen atom or a hydrocarbon group which may be substituted;
each of R⁵ to R¹¹ is independently an alkyl group having 1 or more and 10 or less carbon atoms, a phenyl group, or an aralkyl group having 7 or more and 16 or less carbon atoms, or an alkoxy group having 1 or more and 10 or less carbon atoms;
V is —COO—, —COO(CH₂)ₘ—, —OCO—, —OCO(CH₂)ₘ—, —(CH₂)ₖ—OCO—, —(CH₂)ₖ—COO—, —O—, —CONHCOO—, —CONHCO—, —CONH(CH₂)ₘ—, —SO₂—, —CO—, —CONZ²—, —SO₂NZ²—, or a phenylene group, wherein Z² is a hydrogen atom or a hydrocarbon group having 1 or more and 4 or less carbon atoms, m is an integer of 1 or more and 10 or less, and k is an integer of 1 or more and 3 or less;
W¹ is a single bond, or a single linking group selected from an atomic group of —C(Z³)(Z⁴)—, —(CH═CH)—, a cyclohexylene group, a phenylene group, —O—, —S—, —C(═O)—, —N(Z⁵)—, —COO—, —SO₂—, —CON(Z⁵)—, —SO₂N(Z⁵)—, —NHCOO—, —NHCONH—, and —Si(Z⁵)(Z⁶)—, or a linking group constituted by any combinations thereof, wherein each of Z³ and Z⁴ is a hydrogen atom, a halogen atom, a cyano group, or a hydroxyl group, and Z⁵ and Z⁶ are the same as Z² defined above; and
n is an integer of 5 or more and 130 or less.

7. The liquid developer according to claim 1, wherein the silicone-based macro-monomer represented by the formula (II) is a silicone-based macro-monomer represented by the formula (IIa): 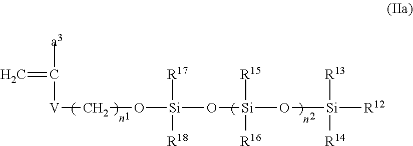
wherein a³ is a hydrogen atom or a methyl group; R¹² to R¹⁸ are an alkyl group having 1 or more and 10 or less carbon atoms, an alkoxy group having 1 or more and 10 or less carbon atoms, a phenyl group, or —(CH₂)ᵣ—C₆H₅, wherein r is an integer of 1 or more and 10 or less; V¹ is —COO— or —CONH—; n¹ is an integer of 1 or more and 10 or less; and n² is an integer of 5 or more and 130 or less.

8. The liquid developer according to claim 1, wherein the weight-average molecular weight of the monomer having a silicone chain is 1,500 or more and 8,000 or less.

9. The liquid developer according to claim 1, wherein the weight-average molecular weight of the copolymer C is 15,000 or more and 60,000 or less.

10. The liquid developer according to claim 1, wherein the polyester resin P is a resin obtained by polycondensing an alcohol component comprising an aliphatic diol having a hydroxyl group bonded to a secondary carbon atom in an amount of 80% by mol or more, and a carboxylic acid component.

11. The liquid developer according to claim 10, wherein the number of carbon atoms of the aliphatic diol is 2 or more and 6 or less.

12. The liquid developer according to claim 1, wherein the polyester resin P is a resin obtained by polycondensing an alcohol component and a carboxylic acid component comprising an aromatic dicarboxylic acid compound in an amount of 80% by mol or more.

13. The liquid developer according claim 1, wherein the polyester resin P is a resin obtained by polycondensing an alcohol component comprising an aliphatic diol having a hydroxyl group bonded to a secondary carbon atom, and a carboxylic acid component comprising an aromatic dicarboxylic acid compound.

14. The liquid developer according to claim 13, wherein the number of carbon atoms of the aliphatic diol is 2 or more and 6 or less.

15. The liquid developer according to claim 13, wherein the content of the aliphatic diol is 50% by mol or more and 100% by mol or less of the alcohol component.

16. The liquid developer according to claim 1, wherein the polyester resin P is a resin obtained by polycondensing an alcohol component comprising an aliphatic diol having a hydroxyl group bonded to a secondary carbon atom in an amount of 80% by mol or more, and a carboxylic acid component comprising an aromatic dicarboxylic acid compound in an amount of 80% by mol or more.

17. The liquid developer according to claim 16, wherein the number of carbon atoms of the aliphatic diol is 2 or more and 6 or less.

18. The liquid developer according to claim 1, wherein a molar ratio of carboxy groups of the polyester resin P to basic functional groups of the copolymer C is 0.5 or more and 30 or less.

19. The liquid developer according to claim 1, wherein the polyester resin P is a resin comprising polyester units in an amount of 60% by mass or more.

20. The liquid developer according to claim 1, wherein the insulating liquid comprises a hydrocarbon solvent.

21. A method for producing a liquid developer, comprising:
step 1: melt-kneading at least a polyester resin P having an acid value of 3 mgKOH/g or more and 80 mgKOH/g or less and a pigment, and pulverizing a kneaded mixture obtained to provide toner particles; and
step 2: dispersing the toner particles obtained in the step 1 in an insulating liquid in the presence of a dispersant,
wherein the dispersant comprises a copolymer C obtained by polymerizing monomers comprising a monomer having a basic functional group and a monomer having a silicone chain, wherein the monomer having a silicone chain has a weight-average molecular weight of 1,000 or more and 10,000 or less, and the copolymer C has a weight-average molecular weight of 10,000 or more and 80,000 or less, and wherein a mass ratio of the monomer having a basic functional group to the monomer having a silicone chain is 3/97 or more and 50/50 or less.

22. The method according to claim 21, wherein the melt-kneading in the step 1 is carried out with an open-roller type kneader.
